(19) United States
(12) Patent Application Publication
(10) Pub. No.: US 2026/0156100 A1
(43) Pub. Date: Jun. 4, 2026

(54) Apparatus and Method for Managing IP Address in a Distributed Computing Environment

(71) Applicant: Spectro Cloud, Inc., San Jose, CA (US)

(72) Inventors: Vipin K. Sharma, Vacaville, CA (US); Nianyu Shen, Santa Clara, CA (US); Fnu Rishi Anand, Tracy, CA (US); Anton Gisli Smith, Stockholm (SE)

(21) Appl. No.: 18/967,070

(22) Filed: Dec. 3, 2024

(51) Int. Cl. H04L 61/5007; H04L 61/5053

(52) U.S. Cl. CPC H04L 61/5007; H04L 61/5053

(57) ABSTRACT

Method and apparatus are provided for managing IP address in a distributed computing environment. The method comprises gathering, by a management agent (MA) of each node in the cluster of nodes, broadcast information of peer nodes; identifying, by the MA of each node in the cluster of nodes, one or more nodes without an overlay IP address using the broadcast information gathered about its peer nodes; electing a candidate node among the one or more nodes without an overlay IP address using the broadcast information gathered about its peer nodes; assigning, by the MA of the candidate node, a next available overlay IP address to the candidate node; and communicating, among the cluster of nodes, in accordance with the assigned overlay IP address of the candidate node.

### FIELD

The present invention relates to the field of distributed computing. In particular, the present invention relates to apparatuses and methods for managing IP address in a distributed computing environment.

### BACKGROUND

The configuration of a dynamic host configuration protocol (DHCP) server is not always influenced by the platform team or operations team responsible for maintaining edge clusters. There may be a few reasons, but usually it is because another team or organization runs the network at each location.

Standard DHCP server behavior prefers to allocate the same IP address to a device, in particular when a client issues a DHCP renew, which can occur when half of the lease time has elapsed. However, once a lease expires, the DHCP server is under no obligation to allocate the same IP address again to a given client. In addition, allocating the same IP address to the device is not guaranteed by the DHCP server, even though they sometimes do.

This DHCP server behavior presents an issue to Kubernetes clusters, as the combination of ETCD (distributed” and “/etc) and control plane components generally does not support hostnames (notably while ETCD does, Kubeadm does not). This means Kubernetes assumes that IP addresses cannot change. If they do, the odds are very high that either the cluster can become degraded, such as lose control plane members, or become non-operational, since ETCD can no longer have quorum in a multi-node cluster.

An example of IP addresses are likely to change is when a cluster is deployed at an edge location. Power loss occurs such that the entire site goes down. At some later time, longer than half of the DHCP lease time, power is restored. All devices power up, and request IP addresses from the DHCP server. The DHCP server can allocate new IP addresses to devices, and it is unlikely that they can receive the same IP address that they had before the power failure.

In addition, single node clusters also suffer, since the control plane is configured to use one of the hosts external IP addresses, for example an IP address on a given physical interface, which if provided by DHCP, is subject to change.

Therefore, there is a need for a self-discovering, self-healing overlay VXLAN network that operates between cluster nodes to address the deficiencies of conventional DHCP servers. This overlay VXLAN network can be configured to handle underlay IP changes, ensuring constant communication and stability within the cluster.

### SUMMARY

Methods and apparatuses are provided for managing IP address in a distributed computing environment. According to aspects of the present disclosure, a processor-implemented method for managing IP address in a distributed computing environment includes gathering, by a management agent (MA) of each node in the cluster of nodes, broadcast information of peer nodes; identifying, by the MA of each node in the cluster of nodes, one or more nodes without an overlay IP address using the broadcast information gathered about its peer nodes; electing a candidate node among the one or more nodes without an overlay IP address using the broadcast information gathered about its peer nodes; assigning, by the MA of the candidate node, a next available overlay IP address to the candidate node; and communicating, among the cluster of nodes, in accordance with the assigned overlay IP address of the candidate node.

In another aspect, an apparatus for managing IP address in a distributed computing environment includes a management agent residing at each node in a cluster of nodes, implemented with one or more processors, coupled to a memory and a network interface, where the management agent is configured to: gather broadcast information of peer nodes; identify one or more nodes without an overlay IP address using the broadcast information gathered about its peer nodes; elect a candidate node among the one or more nodes without an overlay IP address using the broadcast information gathered about its peer nodes; assign a next available overlay IP address to the candidate node; and communicate, among the cluster of nodes, in accordance with the assigned overlay IP address of the candidate node.

Some disclosed embodiments also pertain to a non-transitory computer-readable medium comprising instructions to configure a processor to: receive a cluster specification update, where the cluster specification update includes a container image manifest content that describes an infrastructure of the distributed system; convert the container image manifest content into an operating system bootloader consumable disk image for rebooting one or more nodes in the distributed system; and initiate a system reboot using the operating system bootloader consumable disk image for a node in the one or more clusters of the distributed system to update the node to be in compliance with the cluster specification update.

Consistent with embodiments disclosed herein, various exemplary apparatus, systems, and methods for facilitating the orchestration and deployment of cloud-based applications are described. Embodiments also relate to software, firmware, and program instructions created, stored, accessed, or modified by processors using computer-readable media or computer-readable memory. The methods described may be performed on processors, various types of computers, and computing systems-including distributed computing systems such as clouds. The methods disclosed may also be embodied on computer-readable media, including removable media and non-transitory computer readable media, such as, but not limited to optical, solid state, and/or magnetic media or variations thereof and may be read and executed by processors, computers and/or other devices.

These and other embodiments are further explained below with respect to the following figures.

### BRIEF DESCRIPTION OF THE DRAWINGS

The aforementioned features and advantages of the disclosure, as well as additional features and advantages thereof, will be more clearly understandable after reading detailed descriptions of embodiments of the disclosure in conjunction with the non-limiting and non-exhaustive aspects of following drawings. Like reference numbers and symbols in the various figures indicate like elements, in accordance with certain example embodiments.

FIGS. 1A and 1B illustrate exemplary approaches of representing a portion of a specification of a composable distributed system according to aspects of the present disclosure.

FIG. 2A illustrates an example architecture to build and deploy a composable distributed system according to aspects of the present disclosure.

FIG. 2B illustrates another example architecture to facilitate composition of a distributed system comprising one or more clusters according to aspects of the present disclosure.

FIG. 3A illustrates an exemplary overlay VXLAN network according to aspects of the present disclosure.

FIG. 3B illustrates an example of cluster configuration using an overlay network according to aspects of the present disclosure.

FIG. 4 illustrates an exemplary flowchart of cluster creation on a Kubernetes node according to aspects of the present disclosure.

FIG. 5 illustrates an exemplary implementation of configuring a VXLAN in a distributed computing environment according to aspects of the present disclosure.

FIG. 6 illustrates an exemplary implementation of updating the VXLAN dynamically in response to a node having an IP address change according to aspects of the present disclosure.

FIG. 7 illustrates an exemplary implementation of updating the VXLAN dynamically in response to a node joining the cluster of nodes according to aspects of the present disclosure.

FIG. 8 illustrates an exemplary implementation of updating the VXLAN dynamically in response to removing a node from the cluster of nodes according to aspects of the present disclosure.

FIG. 9 illustrates an exemplary implementation of IP address management among a cluster of nodes in a distributed computing environment according to aspects of the present disclosure.

FIG. 10 illustrates an exemplary implementation of gathering broadcast information of peer nodes according to aspects of the present disclosure.

FIG. 11 illustrates an exemplary implementation of electing a candidate node for IP address assignment according to aspects of the present disclosure.

FIG. 12 illustrates an exemplary implementation of assigning a next available overlay IP to a candidate node according to aspects of the present disclosure.

FIG. 13 illustrates an exemplary flowchart of each node in a cluster of nodes independently manages its IP address allocation while coordinating with its peers according to aspects of the present disclosure.

### DESCRIPTION OF EMBODIMENTS

The following descriptions are presented to enable a person skilled in the art to make and use the disclosure. Descriptions of specific embodiments and applications are provided only as examples. Various modifications and combinations of the examples described herein will be readily apparent to those skilled in the art, and the general principles defined herein may be applied to other examples and applications without departing from the scope of the disclosure. Thus, the present disclosure is not intended to be limited to the examples described and shown, but is to be accorded the scope consistent with the principles and features disclosed herein. The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

Some disclosed embodiments pertain to apparatus, systems, and methods to facilitate specification and deployment of composable end-to-end distributed systems. Apparatus and techniques for the configuration, orchestration, deployment, and management of composable distributed systems and applications are also described.

The term “composable” refers to the capability to architect, build, and deploy customizable systems flexibly based on an underlying pool of resources (including hardware and/or software resources). The term end-to-end indicates that the composable aspects can apply to the entire system (e.g. both hardware and software and to each cluster (or composable unit) that forms part of the system). For example, the resource pool may include various hardware types, several operating systems, as well as orchestration, networking, storage, and/or load balancing options, and/or custom (e.g. user provided) resources. A composable distributed system specification may identify subsets of the above resources and detail, for each subset, a corresponding configuration of the resources in the subset, which may be used to realize (e.g. deploy and instantiate) and manage (e.g. monitor and reconcile) the specified (composable) distributed system. Thus, the composable distributed system may be some specified synthesis of resources (e.g. from the resource pool) and a configuration of those resources. In some embodiments, resources in the resource pool may be selected and configured in order to specify the composable system as outlined herein. Composability, as used herein, also refers to the declarative nature of the system composition specification, which may directed to the composition (or configuration) of the desired distributed system and the state of the desired distributed system rather than focusing on the steps, procedures, and mechanics of how the distributed system is put together. In some embodiments, the desired composition and/or state of the (composable) distributed system may be altered by simply by changing parameters associated with the system composition specification and the specified changes may be automatically implemented as outlined further herein. As an example, because different providers (e.g. cloud providers) may have different procedures/mechanics etc. to implement similar distributed systems, composability frees the user from the mechanics of realizing a desired distributed system and facilitates user focus on the composition and state of desired distributed system without regard to the provider (e.g. whether Amazon or Google Cloud) or the mechanics involved.

For example, resources from the resource pool may be selected and flexibly configured to build the system to match user and/or application specifications at some point in time. In some embodiments, resources from the resource pool may be individually selected, provisioned, scaled, and/or aggregated/disaggregated to match user/application requirements. Aggregation refers to the combining of one or more resources (e.g. memory) so that they may be reside on a smaller subset of nodes (e.g. on a single server) on the distributed system. Disaggregation refers to the distribution of resources (e.g. memory) so that the resource is split between (e.g. distributed across) nodes in the distributed system. For example, when the resource is memory, disaggregation may result in distributing shared memory on a single server to one or more nodes in the distributed system. In composable distributed systems disclosed herein, equivalent resources from the resource pool may be swapped or changed without compromising overall functionality of the composable system. In addition, new resources from the pool may be added and/or existing resources may be updated to enhance system functionality transparently.

Some disclosed embodiments facilitate provisioning and management of end-to-end composable systems and platforms using declarative models. Declarative models facilitate system specification and implementation based on a declared (or desired) state. The specification of composable systems using declarative models facilitates both realization of a desired distributed system (e.g. as specified by a user) and in maintenance of the composition and state of the system (e.g. during operation). Thus, a change in the composition (e.g. change to the specification of the composable system) may result in the change being applied to the composable system (e.g. via the declarative model implementation). Conversely, a deviation from the specified composition (e.g. from failures or errors associated with one or more components of the system) may result in remedial measures being applied so that system compliance with the composed system specification is maintained. In some embodiments, during system operation, the composition and state of the composable distributed system may be monitored and brought into compliance with the specified composition (e.g. as specified or updated) and/or declared state (e.g. as specified or updated).

The term distributed computing, as used herein, refers to the distribution of computing applications across a networked computing infrastructure, including clouds and other virtualized infrastructures. The term cloud refers to virtualized computing resources, which may be scaled up or down in response to computing demands and/or user requests. Cloud computing resources are built over underlying physical hardware including processors, memory, storage, networking, and a software stack, which may be made available as virtual machines (VMs). A VM or virtual node refers to a computer based on configured cloud computing resources (e.g. with processing, memory, storage, networking, and an OS) that may be used to run applications. The term node may refer to a physical computer (physical node) or a VM (virtual node) associated with a distributed system. A cluster is a collection of VMs or nodes that may be interlinked and/or shared and used to run applications.

When the cloud infrastructure is made available (e.g. over a network such as the Internet) to users, the cloud infrastructure is often referred to as Infrastructure as a Service (IaaS). IaaS infrastructure is typically managed by the provider. In the Platform-as-a-Service (PaaS) model, cloud providers may supply a platform, (e.g. with a preconfigured software stack) upon which customers may run applications. PaaS providers typically manage the platform (infrastructure and software stack), while the application runtime/execution environment may be user-managed. Software-as-a-Service (SaaS) models provide ready to use software applications such as financial or business applications for customer use. SaaS providers may manage the cloud infrastructure, any software stacks, and the ready to use applications, while users may retain control of data and tailor application configuration as appropriate.

The term “container” or “application container” as used herein, refers to an isolation unit or environment within a single operating system and may be specific to a running program. When executed in their respective containers, the programs may run sandboxed on a single VM. Sandboxing may depend on OS virtualization features, such as namespaces. OS virtualization facilitates rebooting, provision of IP addresses, memory, processes etc. to the respective containers. Containers may take the form of a package (e.g. an image), which may include the application, application dependencies (e.g. services used by the application), the application's runtime environment (e.g. environment variables, privileges etc.), application libraries, other executables, and configuration files. One distinction between an application container and a VM is that multiple application containers (e.g. each corresponding to a different application) may be deployed over a single OS, whereas, each VM typically runs a separate OS. Thus, containers are often less resource intensive and may facilitate better utilization of underlying host hardware resources. Providers may also deliver container cluster management, container orchestration, and the underlying computational resources to end-users as a service, which is referred to as “Container as a Service” (CaaS).

However, containers may create additional layers of complexity. For example, applications may use multiple containers, which can potentially be deployed across multiple servers based on various system parameters. Thus, container operation and deployment can be complex. To ensure proper deployment, realize resource utilization efficiencies, and optimal run time performance, containers are orchestrated. Orchestration refers to the coordination of tasks associated with a distributed system/distributed applications including instantiation, task sequencing, task scheduling, task distribution, scaling, etc. Orchestration may involve various resources associated with the distributed system including infrastructure, software, and/or services. In general, application deployment may depend on various operational parameters including orchestration (e.g. for cloud-native applications), availability, resource management, persistence, performance, scalability, networking, security, monitoring, etc. These operational parameters may also apply to containers. Accordingly, the use and deployment of containers may also involve extensive customization to ensure compliance with operational parameters. In many instances, to facilitate compliance, containers may be deployed along with VMs or over physical hardware. For example, an application provider may seek to isolate one group of containers (e.g. highly trusted and/or sensitive applications) on one VM (or cluster) while running other containers (e.g. less trusted/less sensitive) on a different cluster. In practice, such operational parameters can lead to an increase distributed application deployment complexity, and/or decrease resource utilization/performance, and/or result in deployment errors (e.g. due to the complexity) that may expose the application to unwanted risks (e.g. security risks).

In some instances, distributed applications, which may be container based applications, may use specialized hardware resources (e.g. graphics processors), which may not be easily available on public clouds. Such systems, where containers are run on physical hardware directly, often demand extensive customization, which, in conventional schemes, can be difficult, expensive to develop and maintain, and limit flexibility and scalability.

Further, in conventional systems, the process of provisioning and managing the OS and orchestrator (e.g. Kubernetes or “K8s”) can be disjoint and error-prone. For example, orchestrator (e.g. K8s) versions may not be compatible with the OS (e.g. CentOS) versions associated with a VM. As another example, specific OS configurations or tweaks, which may facilitate better operational efficiency for an application, may be misconfigured or omitted thereby affecting application deployment, execution, and/or performance. Moreover, one or more first resources (e.g. a load balancer) may depend on a second resource and/or be incompatible with a third resource. Such dependencies and/or incompatibilities may further complicate system specification, provisioning, orchestration, and/or deployment. Further, even in situations where a system has been appropriately configured, the application developer may desire additional customization options that may not be available or made available by a provider and/or depend on manual configuration to integrate with provider resources.

In addition, to the extent that declarative options are available to a container orchestrator (e.g. K8s) in conventional systems, maintaining consistency with declared options is limited to container objects (or to entire VMs that run the containers), but the specification of declarative options at lower levels of granularity are unavailable. Moreover, in conventional systems, the declarative aspects do not apply to system composition-merely to the maintenance of declared states of container objects/VMs. Thus, specification, provisioning, and maintenance of conventional systems may involve manual supervision, be time consuming, inefficient, and subject to errors. Moreover, in conventional systems, upgrades are often effected separately for each component (i.e. on a per component basis) and automatic multi-component/system-wide upgrades are not supported. In addition, for distributed systems with multiple (e.g. K8s) clusters, then, in addition to the issues described above, manual configuration and/or upgrades may result in unintended configuration drifts between clusters.

Some disclosed embodiments pertain to the specification of an end-to-end composable distributed system (including infrastructure, software, services, etc.), which may be used to facilitate automatic configuration, orchestration, deployment, monitoring, and management of the distributed computing system transparently. The term end-to-end indicates that the composable aspects apply to the entire system. For example, a system may be viewed as comprising of a plurality of layers that leverage functionality provided by lower level layers. These layers may comprise: a machine/VM layer, a host OS layer, a guest OS/kernel layer, an orchestration layer, a networking layer, a security layer, one more application or user defined layers, etc. Disclosed composable end-to-end system embodiments may facilitate both: (a) user definition of the layers and (b) specification of components/resources associated with each layer. In some embodiments, the specification of layers and/or the specification of components/resources associated with each layer may be cluster-specific. For example, a first cluster may be specified as being composed with a configuration (e.g. layers and layer components) that is different from the configuration associated with one or more second clusters. In some embodiments, a first plurality of clusters may be specified as sharing a first configuration, while a second plurality of cluster may be specified as sharing a second configuration different from the first configuration. The end-to-end composed distributed system, as composed/tailored by the user, may be orchestrated, deployed, monitored, and managed based on the specified composition and state.

For example, in some embodiments, the specified composition may be implemented using a declarative model, which may reconcile a current (or deployed) composition of the distributed system with the specified composition. For example, a load balancing layer/load balancing component specified as part of the composition of the distributed system may be initiated (if not yet started) or re-started (e.g. if the load balancing component has failed or has exited with errors). In some embodiments, the declarative model may further reconcile an existing state of the distributed system with the declared state. For example, if the number of nodes in a cluster does not correspond to a specified number of nodes, then nodes may be started or stopped as appropriate.

Deployment refers to the process of enabling access to functionality provided by the distributed system (e.g. cloud infrastructure, cloud platform, applications, and/or services). Orchestration refers to the coordination of tasks associated with a distributed system/distributed applications including instantiation, task sequencing, task scheduling, task distribution, scaling, etc. Orchestration may involve obtaining and allocating various resources associated with the distributed system including infrastructure, software, services. Orchestration may also include cloud provisioning, which refers to the process or obtaining and allocating resources and services (e.g. to a user). Configuration refers to the setting up of the various components of a distributed system (e.g. in accordance with a specification). Monitoring, which may be an ongoing process, refers to the process of determining a system state (e.g. number of VMs, workloads, resource use, Quality of Service (QoS), performance, errors, etc.). Management refers to actions that may be taken to administer the distributed system (including applications/services on the system) such as updates, rollbacks, changes (e.g. replacing a first application-such as a load balancer—with a second application), etc. Management may be performed to ensure that the system state complies with policies for the distributed system (e.g. adding appropriate resources when QoS parameters are not met). Management actions may also be taken, for example, in response to input provided by monitoring (e.g. dynamic scaling in response to projected resource demands), and/or some other event, which may be external to the system (e.g. updates and/or rollbacks of applications based on a security issue).

As outlined above, in some embodiments, specification of the composable distributed system may be based on a declarative scheme or declarative model. In some embodiments, based on the specification, components of the distributed system may be automatically configured, orchestrated, deployed, and managed in a consistent and repeatable manner (across systems/cloud providers and across deployments). Further, inconsistencies, dependencies, and incompatibilities may be addressed at the time of specification. In addition, variations from the specified composition (e.g. as outlined in the composable system specification) and/or desired state (e.g. as outlined in the declarative model), may be determined during runtime/execution, and system composition and/or system state may be modified during runtime to match the specified composition and/or desired state. In addition, in some embodiments, changes to the system composition and/or declarative model, which may alter the specified composition and/or desired state, may be automatically and transparently applied to the system. Thus, updates, rollbacks, maintenance, and other changes may be easily and transparently applied to the distributed system. Thus, disclosed embodiments facilitate the specification managing end-to-end composable systems and platforms using declarative models. The declarative model not only provides flexibility in building (composing) the system but also the operation to keep the state consistent with the declared target state.

For example, (a) changes to system composition specification (e.g. selection of a different application for a layer, application updates such as new versions, and/or changes such as additions/deletions of one or more layers) may be monitored; (b) inconsistencies with the specified composition may be identified; and (c) actions may initiated to ensure that the deployed system reflects the modified composition specification. For example, a first load balancer application may be replaced with a second (different) load balancing application if the modified system composition specification indicates that the second load balancing application is to be used. Conversely, when the composition specification has not changed, then runtime failures or errors, which may result in inconsistencies between the running system and the system composition specification, may be flagged, and remedial action may be initiated to bring the running system into compliance with the system composition specification. For example, a load balancing application, which failed or was inadvertently shut down, may be restarted.

As another example, (a) changes to a target (or desired) system state specification (e.g. adding or decreasing a number of VMs in a cluster) may be monitored; (b) inconsistencies between a current state of the system and the target state specification may be identified; and (c) actions may initiated to remediate the inconsistencies (e.g. the number of VM may be adjusted—e.g. new VMs added or existing VMs may be torn down in accordance with the changed target state specification). Conversely, when the target state specification has not changed, then runtime failures or configuration errors, which may result in a current state of the system being inconsistent with the target state specification, may be flagged, and remedial action may be initiated to bring the state of the system into compliance with the target system state specification. For example, a VM that may have crashed or been inadvertently deleted may be restarted/instantiated.

Accordingly, in some embodiments, a declarative implementation of the composable distributed system may ensure that a system converges: (a) in composition with a system composition specification, and/or (b) in state to a target system state specification.

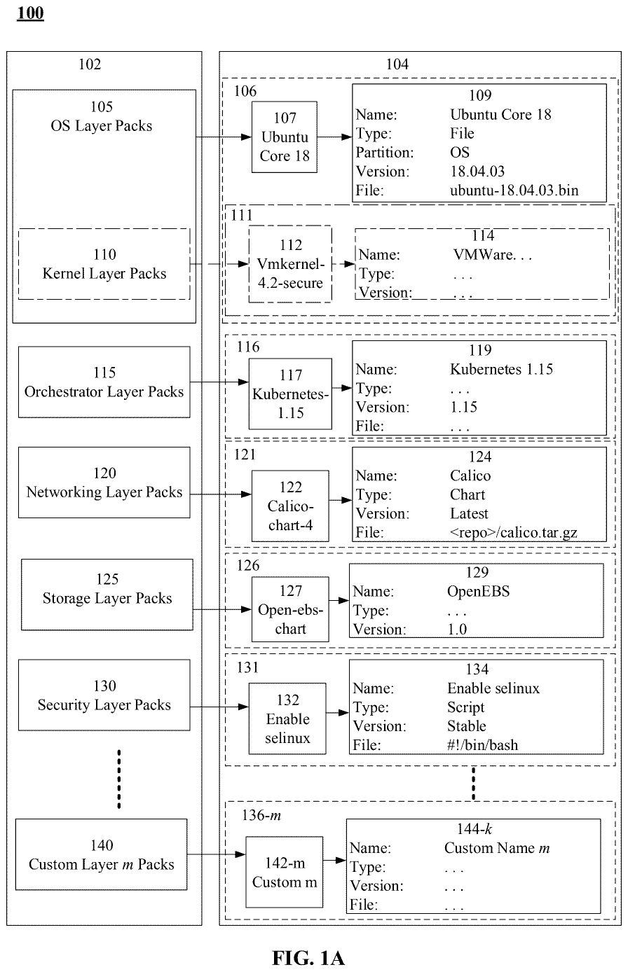

FIGS. 1A and 1B show example approaches for illustrating a portion of a specification of a composable distributed system (also referred to as a “system composition specification” herein). The term “system composition specification” as used herein refers to: (i) a specification and configuration of the components (also referred to as a “cluster profile”) that form part of the composable distributed system; and (iii) a cluster specification, which specifies, for each cluster that forms part of the composable distributed system, a corresponding cluster configuration. The system composition specification, which comprises the cluster profile and cluster specification, may be used to compose the distributed system as described in relation to some embodiments herein. In some embodiments, the cluster profile may specify a sequence for installation and configuration for each component in the cluster profile. Components not specified may be installed and/or configured in a default or pre-specified manner. The components and configuration specified in cluster profile 104 may include (or be viewed as including) a software stack with configuration information for individual software stack components and/or for the software stack as a whole.

As shown in FIG. 1A, a system composition specification may include cluster profile 104, which may be used to facilitate description of a composable distributed system. In some embodiments, the system composition specification may be declarative. For example, as shown in FIG. 1A, cluster profile 104 may be constituted by selecting, associating, and configuring cluster profile components. Each cluster profile component may form a layer or part of a layer and the layers may be invoked in a specified sequence to realize the composable distributed system. The layers themselves may be composable thus providing additional customization flexibility. Cluster profile 104 may be used to define the expected or desired composition of the composable distributed system. In some embodiments, cluster profile 104 may be associated with, a cluster specification. The system composition specification S may be expressed as S={(Cᵢ, Bᵢ)|1≤i≤N}, where Cᵢ is the cluster specification describing the configuration of the i^{th} cluster (e.g. number of VMs in cluster i, number of master nodes in cluster i, number of worker nodes in cluster i, etc.), and Bᵢ is the cluster profile associated with the i^{th} cluster, and N is the number of clusters specified in the composable distributed system specification S. The cluster profile Bᵢ for a cluster may include a cluster-wide software stack applicable across the cluster, and/or a software stack for each node in the cluster and/or may include software stacks (e.g. associated with cluster sub-profiles) for portions (e.g. node pools or sub-clusters) of the cluster.

A host system or Deployment and Provisioning Entity (“DPE”) (e.g. a computer, VM, cloud based deployment/provisioning cluster, or cloud-based service) may obtain and read the cluster profile and cluster specification, and take actions to configure and deploy the composed distributed system (in accordance with system composition specification S), and then manage the running distributed system to maintain consistency with a target state. In some embodiments, the DPE may use cluster profile B, the cluster specification C with associated parameters to build a cluster image for each cluster, which may be used to instantiate and deploy the cluster(s).

As shown in FIG. 1A, cluster profile 104 may comprise a plurality of composable “layers,” which may provide organizational and/or implementation details for various parts of the composable system. In some embodiments, a set of “default” layers that are likely to present in many composable systems may be provided. In some embodiments, a user may further add or delete layers, when building cluster profile 104. For example, a user may add a custom layer and/or delete one of the default layers. As shown in FIG. 1A, cluster profile 104 includes OS layer 106, (which may optionally include a kernel layer 111—e.g. when an OS may be configured with specific kernels), orchestrator layer 116, networking layer 121, storage layer 126, security layer 131, and optionally, one or more custom layers 136-m, 1≤m≤R, where R is the number of custom layers. Custom layers 136-m may be interspersed with other layers. For example, the user may invoke one or more custom layers 136 (e.g. scripts) after execution of one of the layers above (e.g. OS layer 106) and prior to the execution of another (e.g. Orchestrator layer 116). In some embodiments, cluster profile 104 may be entirely comprised of custom layers (which may include an OS layer, orchestrator layer, etc.) configured by a user. Cluster profile 104 may comprise some combination of default and/or custom layers in any order. Cluster profile 104 may also include various cluster profile parameters, which may be associated with layer implementations and configuration (not shown in FIG. 1A).

The components associated with each layer of cluster profile 104 may be selected and configured by a user (e.g. through a Graphical User Interface (GUI)) using cluster profile layer selection menu 102, and the components selected and/or configured may be stored in file such as a JavaScript Object Notation (JSON) file, a Yet Another Meta Language (YAML) file, an XML file, and/or any other appropriate domain specific language file. As shown in FIG. 1A, each layer may be customizable thus providing additional flexibility. For example, cluster profile layer selection menu 102 may provide a plurality of layer packs where each layer pack is associated with a corresponding layer (e.g. default or custom). A layer pack may comprise various cluster profile components that may be associated (either by a provider or a user) with the corresponding layer (e.g. for selection). A GUI may facilitate selection and/or configuration of components associated with a corresponding layer pack. For each layer, cluster profile layer selection menu 102 may facilitate selection of the corresponding available layer components or implementation choices or “Packs”. Packs represent available implementation choices for a corresponding layer. In some embodiments, (a) packs may be built and managed by providers and/or system operators (which are referred to herein as “default packs”), and/or (b) users may define, build and manage packs (which are referred to herein as “custom packs”). User selection of pack components/implementations may be facilitated by cluster profile layer selection menu 102, which may be provided using a GUI. In some embodiments, a user may build the cluster profile by selecting implementations associated with a layers and packs. In some embodiments, based on the selection, the system may automatically include configuration parameters (such as version numbers, image location etc.), and also facilitate inclusion of any additional user defined parameters. In addition, the system may also support orchestration, deployment, and management of a composed system based on the cluster profile (e. g cluster profile 104).

As an example, OS layer pack 105 in cluster profile layer selection menu 102 may include various types of operating systems such as: CentOS 7, CentOS 6, Ubuntu 16, Ubuntu Core 18, Fedora 30, RedHat, etc. In some embodiments, OS layer pack 105 may include inline kernels and cluster profile 104 may not include separate kernel sub-layer 111.

In embodiments, where kernel sub-layer 111 is included, kernel sub-layer pack 110 (which may form part of OS layer pack 105) may include mainline kernels (e.g. which introduce new features and are released per a kernel provider's schedule), long term support kernels (such as the LTS Linux 4.14 kernel and modules), and kernels such as the Linux-ck kernel (which includes patches to improve system responsiveness), real-time kernels (which allows preemption of significant portions of the kernel to be preempted), microkernels such as vmkernel-4.2-secure 112 (as shown in FIG. 1A), vm-kernel-4.2, etc.

Orchestrator layer pack 115 in cluster profile layer selection menu 102 may include orchestrators such as kubernetes-1.15, customized-kubernetes-1.15, docker-swarm-3.1, mesos-1.9.0, apache-airflow-1.10.6 117 (not shown in FIG. 1A) etc.

Networking layer 120 pack in cluster profile layer selection menu 102 may include network fabric implementations such as Calico, kubernetes Container Network Interface (CNI) plugins (e.g. Flannel, WeaveNet, Contiv), etc. Networking layer pack 120 may also include helm chart based network fabric implementations such as a “Calico-chart” (e.g. Calico-chart 4 122, as shown in FIG. 1A). Helm is an application package manager that runs over Kubernetes. A “helm chart” is a specification of the application structure. Calico facilitates networking and the setting up network policies in Kubernetes clusters. Container networking facilitates interaction between containers, the host, and outside networks (e.g. the Internet). The CNI framework outlines a plugin interface for dynamically configuring network resources when containers are provisioned or terminated. The plugin interface (outlined by the CNI specification) facilitates container runtime coordination with plugins to configure networking. CNI plugins may provision and manage an IP address to the interface and may provide functionality for IP management, IP assignment to containers, multi-host connectivity, etc. The term “container runtime” refers to software that executes containers and manages container images on a node. In some embodiments, cluster profile 104 may include a custom runtime layer (not shown) and an associated runtime layer pack (not shown), which may include runtime implementations such as Docker, CRI-O, rkt, ContainerD, RunC, etc.

Storage layer pack 125 in cluster profile selection menu 102 may include storage implementations such as OpenEBS, Portworx, Rook, etc. Storage layer pack 125 may also include helm chart based storage implementations such as a “Open-ebs-chart.” Security layer pack 130 may include helm charts (e.g. nist-190-security-hardening). In some embodiments, cluster profile layer selection menu 102 may provide (or provide an option to specify) one or more user-defined custom layer m packs 140, 1≤m≤R. For example, the user may specify a custom “load balancer layer” (in cluster profile layer selection menu 102) and an associated load balancer layer pack (e.g. as custom layer 1 pack 140-1), which may include load balancers such as F5 Big IP, AviNetworks, Kube-metal, etc.

Any layer pack may include scripts including user-defined scripts that may be run on the system host during provisioning or at some other specified time (during scaling, termination, etc.).

In general, as shown in FIG. 1A, a cluster profile (e.g. cluster profile 104) may comprise several layers (default and/or custom) and appropriate layer implementations (e.g. “Ubuntu Core 18” 107, “Kubernetes 1.15” 117) may be selected for each corresponding layer (e.g. OS layer 106, Orchestrator layer 109, respectively) from the corresponding pack (e.g. OS layer pack 105, Orchestrator layer pack 115, respectively). In some embodiments, cluster profile 104 may also include one or more custom layers 136-m, each associated with a corresponding custom layer implementation 144-m selected from corresponding custom layer pack 140-m in cluster profile layer selection menu 102.

In FIG. 1A, the OS layer 106 in cluster profile layer selection menu 102 is shown as including the “Ubuntu Core 18” 107 along with Ubuntu Core 18 configuration 109, which may specify one or more of: the name, pack type, version, and/or additional pack specific parameters. In some embodiments, the version (e.g. specified in the corresponding configuration) may be a concrete or definite version (e.g., “18.04.03”). In some embodiments, the version (e.g. specified in the corresponding configuration) may be a dynamic version (e.g., specified as “18.04.x” or using another indication), which may resolved to a definite version (e.g. 18.04.03) based on a dynamic to definite version mapping at a cluster provisioning or upgrading time for the corresponding cluster specification associated with cluster profile 104.

Further, kernel layer 111 in cluster profile layer selection menu 102 also includes Vmkernel-4.2-secure 112 along with Vmkernel-4.2-secure configuration 114, which may specify one or more of: the name, pack type, version, along with additional pack specific parameters.

Similarly, orchestrator layer 116 in cluster profile layer selection menu 102 includes Kubernetes-1.15 117 as the orchestrator and is associated with Kubernetes-1.15 configuration 119.

In addition, networking layer 121 in cluster profile layer selection menu 102 includes Calico-chart-4 122 as the network fabric implementation. Calico-chart-4 is associated with Calico-chart-4 configuration 124, which indicates that Calico-chart-4 is a helm chart and may include a repository path/file name (shown as <repo>/calico-v4.tar.gz) to request/obtain the network fabric implementation. Similarly, storage layer 126 in cluster profile layer selection menu 102 includes Open-ebs-chart1.2 127 as the storage implementation and is associated with Open-ebs-chart1.2 configuration 129. Security layer 132 is implemented in cluster profile 104 using the “enable selinux” script 132, which is associated with “enable selinux” configuration 134 indicating that “enable selinux” is a script and specifying path/filename (shown as $!/bin/bash). Cluster profile layer selection menu 102 may also include addition custom layers 136-i, each associated with corresponding custom implementation 142-k and custom implementation configuration 144-k.

In some embodiments, when a corresponding implementation (e.g. Ubuntu Core 18) is selected for a layer (e.g. OS layer 106), then: (a) all pre-requisites for running the selected implementation may also be included and/or specified when the implementation is selected; and/or (b) any incompatible implementations for another layer (e.g. orchestrator layer 116) may be excluded from selection menu 102. Thus, cluster profile layer selection menu 102 may prevent incompatible inter-layer implementations from being used together thereby preventing potential failures, errors, and decreasing the need for later rollbacks and/or reconfiguration. Intra-layer incompatibilities (within a layer), may also be avoided by: (a) ensuring selection of implementations that are to be used together (e.g. dependent); and/or (b) preventing selection of incompatible implementations that are available with a layer. For example, mini cluster profiles may be created within a layer (e.g. after testing) to ensure that dependencies and/or incompatibilities are addressed. In addition, because individual layers are customizable and the granularity of layers in the cluster profile is also customizable, greater flexibility is system composition is facilitated at every layer and for the system as a whole. Because both the number of layers as well as the granularity of each layer can be user-defined (e.g. via customizations), end-to-end distributed system composability is facilitated. For example, a user may fine tune customizations (higher granularity) for layers/portions of a cluster profile, which are of interest, but use lower levels of granularity for other layers/portions of the cluster profile.

The use of cluster profiles, which may be tested, published, and re-used, facilitates consistency, repeatability, and facilitates system wide maintenance (e.g. rollbacks/updates). Further, by using a declarative model to realize the distributed system (as composed)-compliance with the system composition specification (e.g. as outlined in the cluster profile and cluster specification) can be ensured. Thus, disclosed embodiments facilitate both flexibility and control when defining distributed system composition and structure. In addition, disclosed embodiments facilitate customization (e.g. specification of layers and packs for each layer), selection (e.g. selecting available components in a pack) and configuration (e.g. parameters associated with layers/components) of: the bootloader, operating system, kernel, system applications, tools and services, as well as orchestrators like Kubernetes, along with applications and services running in Kubernetes. Disclosed embodiments also ensure compliance with a target system state specification based on a declarative model. As an example, a declarative model implementation may: (a) periodically monitor distributed system composition and/or system state during distributed system deployment, orchestration, run time, maintenance, and/or tear down (e.g. over the system lifecycle); (b) determine that a current system composition and/or current system state is not in compliance with a system composition specification and/or target system state specification, respectively; and (c) effectuate remedial action to bring system composition into compliance with the system composition specification and/or the target system state specification, respectively. In some embodiments, the remedial action to bring system composition into compliance with the system composition specification and/or the target system state specification, respectively, may be effectuated automatically (without user intervention when variance with the specified composition and/or target system state is detected), dynamically (e.g. during runtime operation of the distributed system). Remedial actions may be effectuated dynamically both in response to composition specification changes and/or target system state specification changes as well as operational or runtime deviations (e.g. from errors/failures during system operation). Moreover, some disclosed embodiments also support increased distributed system availability and optimize system performance because remediation in response to variance (e.g. from the specified composition and/or target system state) is focused on addressing the current variance (e.g. delta from the specified composition and/or target system state). as opposed to rebuilding and/or redeploying the entire system. For example, a single node (that may have failed) may be restarted and/or a newly specified load balancer may be used in place on existing load balancer.

FIG. 1B shows another example approach illustrating the specification of composable distributed applications. As shown in FIG. 1B, cluster profile may be pre-configured and presented to the user as pre-defined cluster profile 150 in a cluster profile selection menu 103. In some embodiments, a provider or user may save or publish the cluster profiles (e.g. after testing), which may then be selected and used by other users thereby simplifying orchestration and deployment. FIG. 1B shows pre-defined profiles 150-j, 1≤j≤Q. In some embodiments, user may add customizations to pre-defined profile 150 by adding custom layers i and/or modifying pack selection for a layer and/or deleting layers. The user customized layer may be saved (e.g. after testing) and/or published (e.g. shared with other users) as a new pre-defined profile.

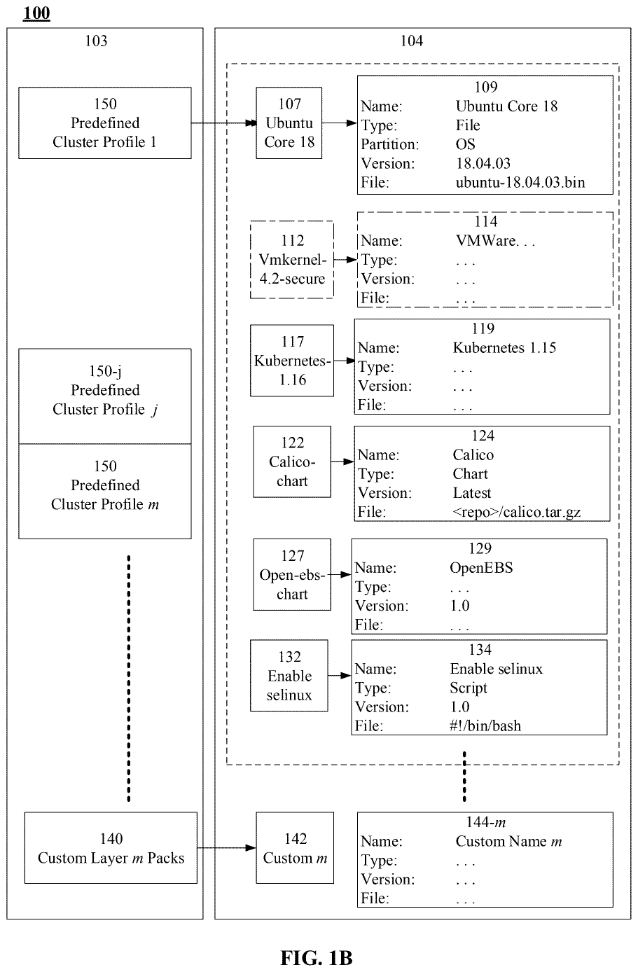

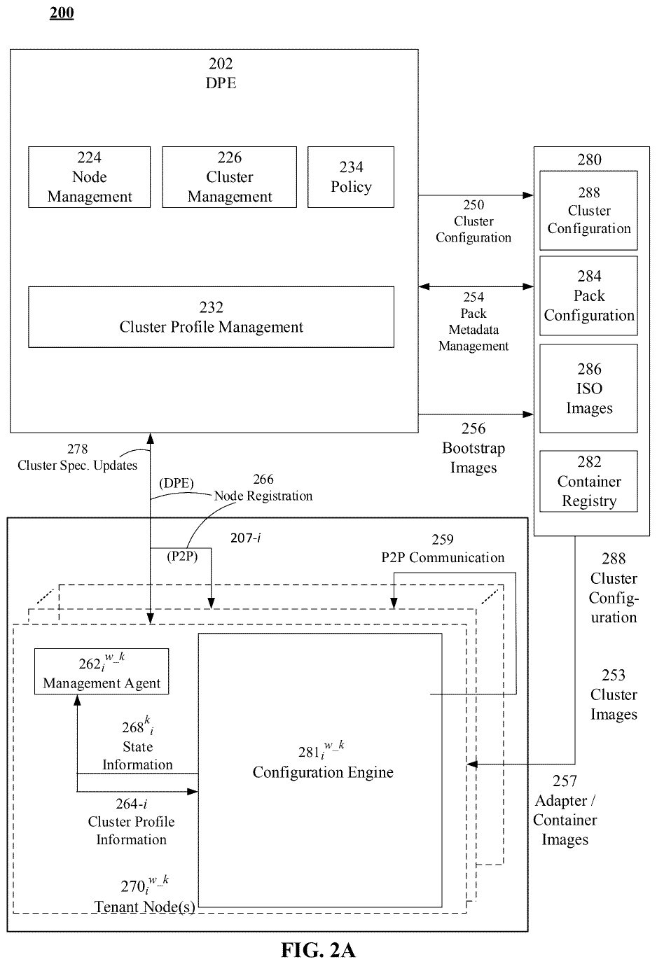

FIG. 2A shows an example architecture 200 to build and deploy a composable distributed system. Architecture 200 may support the specification, orchestration, deployment, monitoring, and updating of a composable distributed system in accordance with some disclosed embodiments. In some embodiments, one or more of the functional units of the composable distributed system may be cloud-based. In some embodiments, the composable distributed system may be implemented using some combination of: cloud based systems and/or services, and/or physical hardware (e.g. a computer with a processor, memory, network interface, and/or with computer-readable media). For example, DPE 202 may take the form of a computer with a processor, memory, network interface, and/or with computer-readable media, and/or a VM.

In some embodiments, architecture 200 may comprise DPE 202, one or more clusters Tᵢ 207-i (also referred to as “tenant clusters”), and repository 280. Composable distributed system may be specified using system composition specification S={(Cᵢ, Bᵢ)|1≤i≤N} 150, where Tᵢ 207-i corresponds to the cluster specified by cluster specification Cᵢ 180 and each node

$$27 {0}_{i}^{w \_ k}$$

in cluster Tᵢ 207-i may be configured in a manner consistent with cluster profile Bᵢ 104-i. Further, each node

$$27 {0}_{i}^{w \_ k}$$

in cluster Tᵢ 207-i may form part of a node pool k, wherein each node pool k in cluster Tᵢ 207-i is configured in accordance with cluster specification Cᵢ 180. In some embodiments, composable distributed system may thus comprise a plurality of clusters Tᵢ 207-i, where each node

$${270}_{i}^{w\_k}$$

in node pool k may share a similar configuration, where 1≤k≤P and P is the number of node pools in cluster Tᵢ 207-i; and 1≤w≤W_k, where W_k is the number of nodes in node pool k in cluster Tᵢ 207-i.

For example, DPE 202, which may serve as a configuration, management, orchestration, and deployment interface, may be provided as a cloud-based service (e.g. SaaS), while the user-composed distributed system may run over physical hardware. As another example, DPE 202 may be provided as a cloud-based service (e.g. SaaS), and the user-composed distributed system may run on cloud-infrastructure (e.g. a private cloud, public cloud, and/or a hybrid public-private cloud). As a further example, DPE 202 may be a server running on a physical computer, and the user-composed distributed system may be deployed (initially) over bare metal (BM) nodes. The term “bare metal” is used to refer to a computer system without an installed base OS and without installed applications. In some embodiments, the bare metal system may include firmware or flash/Non-Volatile Random Access Memory (NVRAM) memory program code (also referred to herein as “pre-bootstrap code”), which may support some operations such as network connectivity and associated protocols.

In some embodiments, DPE 202 may provide an interface to compose, configure, orchestrate, and deploy distributed systems/applications. DPE 202 may also provide functionality to enable logging, monitoring, and compliance with the desired state (e.g. as indicated in a declarative model/composable system specification 150 associated with the distributed system). DPE 202 may include a user interface (UI), which may facilitate user interaction in relation to one or more of the functions outlined above. In some embodiments, DPE 202 may be accessed remotely (e.g. over a network such as the Internet) through the UI and used to invoke, provide input to and/or to receive/relay information from one or more of: Node management block 224, Cluster management block 226, Cluster profile management 232, Policy management block 234, and/or configure monitoring block 248.

Node management 224 may facilitate registration, configuration, and/or dynamic management of user nodes (including VMs), while cluster management block 228 may facilitate configuration and/or dynamic management of clusters Tᵢ 207-i. Node management block 224 may also include functionality to facilitate node registration. For example, when DPE 202 is provided as a SaaS, and the initial deployment occurs over BM nodes, each tenant node

$${270}_{i}^{w\_k}$$

may register with node management 224 on DPE 202 to exchange node registration information (DPE) 266, which may include node configuration and/or other information.

In some embodiments, nodes may obtain and/or exchange node registration information (P2P) 266 by initiating discovery of other nodes in the network using automatic peering or peer-to-peer (P2P) discovery and obtain configuration information from peers (e.g. from a master node or lead node in a node pool k) using P2P communication 259. In some embodiments, a node

$${270}_{i}^{w\_k}$$

that detects no other nodes (e.g. a first node in a to-be-formed in node pool k in cluster Tᵢ 207-i) may configure itself as the lead node

$${270}_{i}^{l\_k}$$

(designated with the superscript “l”) and initiate formation of node pool k in cluster Tᵢ 207-i based on a corresponding cluster specification Cᵢ 180. In some embodiments, specification Cᵢ 180 may be obtained from DPE 202 as cluster specification update information 278 and/or by management agent

$${262}_{i}^{k}$$

from a peer node (e.g. when cluster Tᵢ 207-i has already been formed).

Cluster profile management block 232 may facilitate the specification and creation of cluster profile 104 for composable distributed systems and applications. For example, cluster profiles (e.g. cluster profile 104 in FIG. 1A) may be used to facilitate composition of one or more distributed systems and/or applications. As an example, a UI may provide cluster profile layer selection menu 102 (FIG. 1A), which may be used to create, delete, and/or modify cluster profiles. Cluster profile related information may be stored as cluster configuration information 288 in repository 280. In some embodiments, cluster configuration related information 288 (such as Ubuntu Core 18 configuration 109) may be used during deployment and/or to create a cluster profile definition, which may be stored, updated, and/or obtained from repository 280. Cluster configuration related information 288 in repository 280 may further include cluster profile parameters 155. In some embodiments, cluster configuration related information 288 may include version numbers and/or version metadata (e.g. “latest”, “stable” etc.), credentials, and/or other parameters for configuration of a selected layer implementation. In some embodiments, adapters for various layers/implementations may be specified and stored as part of cluster configuration related information 288. Adapters may be managed using cluster profile management block 232. Adapters may facilitate installation and/or configuration of layer implementations on a composed distributed system.

Pack configuration information 284 in repository 280 may further include information pertaining to each pack, and/or pack implementation such as: an associated layer (which may be a default or custom layer), a version number, dependency information (i.e. prerequisites such as services that the layer/pack/implementation may depend on), incompatibility information (e.g. in relation to packs/implementations associated with some other layer), file type, environment information, storage location information (e.g. a URL), etc.

In some embodiments, pack metadata management information 254, which may be associated with pack configuration information 284 in repository 280, may be used (e.g. by DPE 202) to configure and/or to re-configure a composable distributed system, For example, when a user or pack provider updates information associated with a cluster profile 104, or updates a portion of cluster profile 104, or then, pack configuration information 284 may be used to obtain pack metadata management information 254 to appropriately update cluster profile 104. When information related to a pack, or pack/layer implementation is updated, then pack metadata management information 254 may be used to update information stored in pack configuration information 284 in repository 280.

If cluster profiles 104 use dynamic versioning (e.g. labels such as “Stable,” or “1.16.x” or “1.16” etc.), then the version information may be checked (e.g. by an Orchestrator) at cluster deployment or cluster update time to resolve to a concrete or definitive version (e.g. “1.16.4”). For example, pack configuration information 284 may indicate that the most recent “Stable” version for a specified implementation in a cluster profile 104 is “1.16.4.” Dynamic version resolution may leverage functionality provided by DPE 202 and/or Management Agent 262. As another example, when a provider or user releases a new “Stable” version for an implementation, then pack metadata management information 254 may be used to update pack configuration information 284 in repository 280 to indicate that the most recent “Stable” version for an implementation may be version “1.16.4.” Pack metadata management information 254 and/or pack configuration information 284 may also include additional information relating to the implementation to enable the Orchestrator to obtain, deploy, and/or update the implementation.

In some embodiments, cluster profile management block 232 may provide and/or management agent 262 may obtain cluster specification update information 278 and the system (state and/or composition) may be reconfigured to match the updated cluster profile (e.g. as reflected in the updated system composition specification S 150). Similarly, changes to the cluster specification 180 may be reflected in cluster specification updates 278 (e.g. and in the updated system composition specification S 150), which may be obtained (e.g. by management agent 262) and the system (state and/or composition) may be reconfigured to match the updated cluster profile.

In some embodiments, cluster profile management block 232 may receive input from policy management block 234. Accordingly, in some embodiments, the cluster profile configurations and/or cluster profile layer selection menus 102 presented to a user may reflect user policies including QoS, price-performance, scaling, cost, availability, security, etc. For example, if a security policy specifies one or more parameters to be met (e.g. “security hardened”), then, cluster profile selections and/or layer implementations that meet or exceed the specified security policy parameters may be displayed to the user for selection/configuration (e.g. during cluster configuration and/or in cluster profile layer selection menu 102), when composing the distributed system/applications (e.g. using a UI). When DPE 202 is implemented as an SaaS, then policies and/or policy parameters that affect user menu choices or user cluster configuration options may be stored in a database (e.g. associated with DPE 202).

Application or application instances may be configured to run on a single VM/node, and/or placed in separate VMs/nodes in a node pool k in cluster 207-i. Container applications may be registered with the container registry 282 and images associated with applications may be stored as an ISO image in ISO Images 286. In some embodiments, ISO images 286 may also store bootstrap images, which may be used to boot up and initiate a configuration process for bare metal tenant nodes

$${270}_{i}^{w\_k}$$

resulting in the configuration of a bare metal node pool k in tenant node cluster 207-i as part of a composed distributed system in accordance with a corresponding system composition specification 150. Bootstrap images for a cluster Tᵢ 207-i may reflect cluster specification information 180-i as well as corresponding cluster profile Bᵢ 104-i.

The term bootstrap or booting refers to the process of loading basic program code or a few instructions (e.g. Unified Extensible Framework Interface (UEFI) or basic input-output system (BIOS) code from firmware) into computer memory, which is then used to load other software (e.g. such as the OS). The term pre-bootstrap as used herein may refers to program code (e.g. firmware) that may be loaded into memory and/or executed to perform actions prior to initiating the normal bootstrap process and/or to configure a computer to facilitate later boot-up (e.g. by loading OS images onto a hard drive etc.). ISO images 286 in repository 280 may be downloaded as cluster images 253 and/or adapter/container images 257 and flashed to tenant nodes

$${270}_{i}^{w\_k}$$

(e.g. by an orchestrator, and/or a management agent

$${262}_{i}^{w\_k}$$

and/or by configuration engine

$${281}_{i}^{w\_k} ) .$$

In some embodiments, tenant nodes

$${270}_{i}^{w\_k}$$

may each include a corresponding configuration engine

$${281}_{i}^{w\_k}$$

and/or a corresponding management agent

$${262}_{i}^{w\_k} .$$

### Configuration Engine

$${281}_{i}^{w\_k} ,$$

which, in some instances, may be similar for all nodes

$${270}_{i}^{w\_k}$$

in a pool k or in a cluster Tᵢ 207-i may include functionality to perform actions (e.g. on behalf of a corresponding a node

$${270}_{i}^{w\_k}$$

or node pool) to facilitate cluster/node pool configuration.

In some embodiments, configuration engine

$${281}_{i}^{l \_ k}$$

for a lead node

$${270}_{i}^{l\_k}$$

in a node pool may facilitate interaction with management agent

$${262}_{i}^{l\_k}$$

and with other entities (e.g. directly or indirectly) such as DPE 202, repository 280, and/or another entity (e.g. a “pilot cluster”) that may be configuring lead node

$${270}_{i}^{l\_k}$$

In some embodiments, configuration engine

$${281}_{i}^{w\_k}$$

for a (non-lead) node

$${270}_{i}^{w\_k} ,$$

w≠l may facilitate interaction with management agents

$${262}_{i}^{w\_k}$$

and/or other entities (e.g. directly or indirectly) such as a lead node

$${270}_{i}^{l\_k}$$

and/or another entity (e.g. a “pilot cluster”) that may be configuring the cluster/node pool.

In some embodiments, management agent

$${262}_{i}^{w\_k}$$

for a node

$${270}_{i}^{w\_k}$$

may include functionality to interact with DPE 202 and configuration engines

$${281}_{i}^{w\_k} ,$$

monitor, and report a configuration and state of a tenant node

$${270}_{i}^{w\_k} ,$$

provide cluster profile updates (e.g. received from an external entity such as DPE 202, a pilot cluster, and/or a lead tenant node

$${270}_{i}^{l\_k}$$

for a node pool k in cluster 207-i) to configuration engine 281-i. In some embodiments, management agent

$${262}_{i}^{w\_k}$$

may be part of pre-bootstrap code in a bare metal node

$${270}_{i}^{w\_k}$$

(e.g. which is part of a node pool k with bare metal nodes in cluster 207-i), may be stored in non-volatile memory on the bare metal node

$${270}_{i}^{w \_ k} ,$$

and executed in memory during the pre-bootstrap process. Management agent

$${262}_{i}^{w \_ k}$$

may also run following vout-up (e.g. after BM nodes

$${270}_{i}^{w \_ k}$$

have been configured as part of the node pool/cluster).

In some embodiments, tenant node(s)

$${270}_{i}^{w \_ k}$$

where 1≤w≤W_k, and W_k is the number of nodes in node pool k in cluster Tᵢ 207-i, may be “bare metal” or hardware nodes without an OS, that may be composed into a distributed computing system (e.g. with one or more clusters) in accordance with system composition specification 150 as specified by a user. Tenant nodes

$${270}_{i}^{w \_ k}$$

may be any hardware platform (e.g. a cluster of rack servers) and/or VMs. For the purposes of the description below, tenant nodes are assumed to be “bare metal” hardware platforms-however, the techniques described may also applied to VMs.

The term “bare metal” (BM) is used to refer to a computer system without an installed base OS and without installed applications. In some embodiments, the bare metal system may include firmware or flash/Non-Volatile Random Access Memory (NVRAM) memory program code, which may support some operations such as network connectivity and associated protocols.

In some embodiments, a tenant node

$${270}_{i}^{w \_ k}$$

may be configured with a pre-bootstrap code (e.g. in firmware, memory (e.g. flash memory), and/or storage). In some embodiments, the pre-bootstrap code may include a management agent

$${262}_{i}^{w \_ k} ,$$

which may be configured to register with DPE 202 (e.g. over a network) during the pre-bootstrap process. For example, management agent 262 may be built over (and/or leverage) standard protocols such as “bootp”. Dynamic Host Configuration Protocol (DHCP), etc. In some embodiments, the pre-bootstrap code may include a management agent 262, which may be configured to: (a) perform a local network peer-discovery and initiate formation of a node pool and/or cluster Tᵢ 207-i and/or join an appropriate node pool and/or cluster Tᵢ 207-i; and/or (b) initiate contact with DPE 202 to initiate formation of a node pool and/or cluster Tᵢ 207-i and/or join an appropriate node pool and/or cluster Tᵢ 207-i.

In some embodiments (e.g. where DPE 202 is provided as an SaaS, BM pre-bootstrap nodes (also termed “seed nodes”) may initially announce themselves (e.g. to DPE 202 or to potential peer nodes) as “unassigned” BM nodes. Based on cluster specification information 180 (e.g. available to management agent 262-k and/or DPE 202), the nodes may be assigned to and/or initiate formation of a node pool and/or cluster Tᵢ 207-i as part of the distributed system composition orchestration process. For example, management agent

$${262}_{i}^{k}$$

may initiate formation of node pool k and/or cluster Tᵢ 207-i and/or initiate the process of joining an existing node pool k and/or cluster Tᵢ 207-i. For example, management agent

$${262}_{i}^{w \_ k}$$

may obtain cluster images 253 from repository 280 and/or from a peer node based on the cluster specification information 180-i.

In some embodiments, where tenant node

$${270}_{i}^{w \_ k}$$

is configured with standard protocols (e.g. bootp/DHCP), the protocols may be used to download the pre-bootstrap program code, which may include management agent

$${262}_{i}^{w \_ k}$$

and/or include functionality to connect to DPE 202 and initiate registration. In some embodiments, tenant node

$${270}_{i}^{w \_ k}$$

may register initially as an unassigned node. In some embodiments, the management agent

$${262}_{i}^{w \_ k}$$

may: (a) obtain an IP address via DHCP and discover and/or connect with the DPE 202 (e.g. based on node registration information (DPE) 266); and/or (b) obtain an IP address via DHCP and discover and/or connect with a peer node (e.g. based on node registration information (P2P) 266).

In some embodiments, DPE 202 and/or the peer node may respond (e.g. to lead management agent

$${262}_{i}^{l \_ k}$$

on a lead tenant node

$${270}_{i}^{l \_ k} )$$

with information including: node registration information 266, cluster specification update information 278. Cluster specification update information 278 may include one or more of: cluster specification related information (e.g. cluster specification 180-i and/or information to obtain cluster specification 180-i and/or information to obtain cluster images 253), a cluster profile definition (e.g. cluster profile 104-i for a system composition specification S 150) for node pool k and/or a cluster associated with lead tenant node

$${270}_{i}^{l \_ k} .$$

In some embodiments, DPE 202 and/or a peer node may respond (e.g. to management agent

$${262}_{i}^{l \_ k}$$

on a lead tenant node

$${270}_{i}^{l \_ k} )$$

by indicating (e.g. that one or more of the other tenant nodes 270, w≠l are to obtain registration, cluster specification, cluster profile, and/or image information from lead tenant node

$${270}_{i}^{k = l} .$$

Tenant nodes

$${270}_{i}^{w \_ k} ,$$

w≠l that have not been designated as the lead tenant node may terminate connections with DPE 202 (if such communication has been initiated) and communicate with or wait for communication from lead tenant node

$${270}_{i}^{l \_ k} .$$

In some embodiments, tenant nodes

$${270}_{i}^{w \_ k} ,$$

w≠l that have not been designated as the lead tenant node may obtain node registration information 266 and/or cluster profile updates 278 (e.g. registration, cluster specification, cluster profile and/or image information from lead tenant node

$${270}_{i}^{l \_ k}$$

directly via P2P discovery without contacting DPE 202.

In some embodiments, a lead tenant node

$${270}_{i}^{l \_ k}$$

may use a P2P communication to determine when to initiate formation of a node pool and/or cluster (e.g. where node pool k and/or cluster Tᵢ 207-i has not yet been formed), or a tenant node

$${270}_{i}^{w \_ k} ,$$

w≠l may use P2P communication to detect existence of a cluster Tᵢ 207-i and lead tenant node 270 (e.g. where formation of node pool k and/or cluster Tᵢ 207-i has previously been initiated) to join the existing cluster. In some embodiments, when no response is received from an attempted P2P communication (e.g. with a lead tenant node

$${270}_{i}^{l \_ k} ) ,$$

a tenant node

$${270}_{i}^{w \_ k} ,$$

w≠l may initiate communication with DPE 202 as an ““unassigned node” and may receive cluster specification updates 278 and/or node registration information 266 to facilitate: (a) cluster and/or node pool formation (e.g. where formation of a node pool and/or cluster has not yet been initiated); or (b) join an existing node pool and/or cluster (e.g. where formation of a node pool and/or cluster has been initiated). In some embodiments, any of the tenant nodes

$${270}_{i}^{w \_ k}$$

may be capable of serving as a lead tenant node

$${270}_{i}^{l \_ k} .$$

Accordingly, in some embodiments, tenant nodes

$${270}_{i}^{w \_ k}$$

in a node pool and/or cluster Tᵢ 207-i may be configured similarly.

Upon registration with DPE 202 (e.g. based, in part, on functionality provided by Node Management block 224), lead tenant node

$${270}_{i}^{l\_k}$$

may receive system composition specification S 150 and/or information to obtain system composition specification S 150. Accordingly, lead tenant node

$${270}_{i}^{l}$$

may: (a) obtain a cluster specification and/or cluster profile (e.g. cluster profile 104-i) and/or information pertaining to a cluster specification or cluster profile (e.g. cluster profile 104-i), and/or (b) may be assigned to a node pool and/or cluster Tᵢ 207-i and/or receive information pertaining to a node pool and/or Tᵢ 207-i (e.g. based on functionality provided by cluster management block 226).

In some embodiments, (e.g. when nodes

$${270}_{i}^{k}$$

are BM nodes), medium access control (MAC) addresses associated with a node may be used to designate one or more nodes as lead nodes and/or to assign nodes to a node pool and/or cluster Tᵢ 207-i based on parameters 155 and/or cluster specification 180 (e.g. based on node pool related specification information 180-k for a node pool k). In some embodiments, the assignment of nodes to node pools and/or clusters, and/or the assignment of cluster profiles 104 to nodes, may be based on stored cluster/node configurations provided by the user (e.g. using node management block 224 and/or cluster management block 226). For example, based on stored user specified cluster and/or node pool configurations, hardware specifications associated with a node

$${270}_{i}^{w\_k}$$

may be used to assign nodes to node pools/clusters and/or to designate one or more nodes as lead nodes for a cluster (e.g. in conformance with cluster specification 180/node pool related specification information 180-k).

As one example, node MAC addresses and/or another node identifier may be used as an index to obtain a corresponding node hardware specification and determine a node pool assignment and/or cluster assignment, and/or role (e.g. lead or worker) for the node. In some embodiments, various other protocols may be used to designate one or more nodes as lead/worker nodes for a node pool and/or cluster, and/or to assign nodes to node pools and/or clusters. For example, a sequence or order in which the nodes

$${270}_{i}^{w\_k}$$

contact DPE 207, a subnet address, IP address, etc. for nodes

$${270}_{i}^{w\_k}$$

may be used to assign nodes to node pools and/or clusters, and/or to designate one or more nodes as lead nodes for a cluster. In some embodiments, unrecognized nodes may be placed, at least initially, in a default or fallback node pool/cluster, and may be reassigned to (and/or may initiate formation of) another cluster upon determination of node specification and/or other node information.

In some embodiments, as outlined above, management agent

$${262}_{i}^{l\_k}$$

on lead tenant node

$${270}_{i}^{l\_k}$$

for a cluster Tᵢ 207-i may receive cluster profile updates 278, which may include system composition specification S 150 (including cluster specification 180-i and cluster profile 104-i) and/or information to obtain system composition specification S 150 specifying the user composed distributed system 200. Management agent

$${262}_{i}^{l\_k}$$

on lead tenant node

$${270}_{i}^{l\_k}$$

may use the received information to obtain a corresponding cluster configuration 288. In some embodiments, based on information in pack configuration 284 and cluster configuration information 288, and/or cluster images 253 may be obtained (e.g. by lead tenant node

$${270}_{i}^{l\_k} )$$

from ISO images 286 in repository 280. In some embodiments, cluster images

$${253}_{i}^{l\_k}$$

(for a node pool k in cluster Tᵢ 207-i) may include OS/Kernel images. In some embodiments, lead tenant node

$${270}_{i}^{l\_k}$$

and/or management agent

$${262}_{i}^{l\_k}$$

may further obtain any other layer implementations (e.g. Kubernetes 1.14, Calico v4, etc.) including custom layer implementations/scripts, adaptor/container images 257 from ISO images 286 on repository 280. In some embodiments, management agent

$${262}_{i}^{l\_k}$$

and/or another portion of the pre-bootstrap code may also format the drive and build a composite image that includes the various downloaded implementations/images/scripts and flash the downloaded images/constructs to the lead tenant node

$${270}_{i}^{l\_k} .$$

In some embodiments, the composite image may be flashed (e.g. to a bootable drive) on lead tenant node

$${270}_{i}^{l\_k} .$$

A reboot of lead tenant node

$${270}_{i}^{l\_k}$$

may then be initiated (e.g. by management agent

$${262}_{i}^{k} ) .$$

The lead tenant node

$${270}_{i}^{l\_k}$$

may reboot to the OS (e.g. based on the flashed composite image, which includes the OS image) and following reboot may execute any initial custom layer implementation (e.g. custom implementation 142-i) scripts. For example, lead tenant node

$${270}_{i}^{l\_k}$$

may perform tasks such as network configuration (e.g. based on cluster specification 180 and/or corresponding node pool related specification 180-k), or enable kernel modules (e.g. based on cluster profile parameters 155-i), re-label the filesystem for selinux (e.g. based on cluster profile parameters 155-i), or other procedures to ready the node for operation. In addition, following reboot, tenant node

$${270}_{i}^{l\_k} / management agent {262}_{i}^{l\_k}$$

may also run implementations associated with other default and/or custom layers. In some embodiments, following reboot, one or more of the tasks above may be orchestrated by Configuration Engine

$${281}_{i}^{l\_k}$$

on lead tenant node

$${270}_{i}^{l\_k} .$$

In some embodiments, lead tenant node

$${270}_{i}^{l\_k}$$

and/or management agent

$${262}_{i}^{l\_k}$$

may further obtain and build cluster images (e.g. based on cluster configuration 288 and/or pack configuration 284 and/or cluster images 253 and/or adapter container images 257 from repository 280), which may be used to configure one or more other tenant nodes

$${270}_{i}^{w\_k}$$

(e.g. when another tenant node

$${270}_{i}^{w\_k}$$

requests node registration 266 with node

$${270}_{i}^{l\_k}$$

using a peer-to-peer protocol) in cluster 207-i.

In some embodiments, upon reboot, lead tenant node

$${270}_{i}^{l\_k}$$

and/or lead management agent

$$26 {2}_{i}^{l\_k}$$

may indicate its availability and/or listen for registration requests from other nodes

$$27 {0}_{i}^{w\_k} .$$

In response to requests from a tenant node

$$27 {0}_{i}^{w\_k} ,$$

w≠l using P2P communication 259, lead tenant node

$$27 {0}_{i}^{l\_k}$$

may provide the cluster images to tenant node

$$27 {0}_{i}^{w\_k} ,$$

w≠l. In some embodiments, Configuration Engine

$$28 {1}_{i}^{w\_k}$$

and/or management agent

$$26 {2}_{i}^{l\_k}$$

may include functionality to support P2P communication 259. Upon receiving the cluster image(s), tenant node

$$27 {0}_{i}^{w\_k} ,$$

w≠l may build a composite image that includes the various downloaded implementations/images/scripts and may flash the downloaded images/constructs (e.g. to a bootable drive) on tenant node

$$27 {0}_{i}^{w\_k} ,$$

w≠l.

In some embodiments, where tenant nodes

$$27 {0}_{i}^{w\_k} ,$$

w≠l form part of a public or private cloud, DPE 202 may use cloud adapters (not shown in FIG. 2A) to build to an applicable cloud provider image format such as Qemu Copy On Write (QCOW), Open Virtual Applications (OVA), Amazon Machine Image (AMI), etc. The cloud specific image may then uploaded to the respective image registry (which may specific to the cloud type/cloud provider) by DPE 202. Thus, in some embodiments, repository 280 may include one or more cloud specific image registries, where each cloud image registry may be specific to a cloud. In some embodiments, DPE 202 may then initiate node pool/cluster setup for cluster 207-i using appropriate cloud specific commands. In some embodiments, cluster setup may result in the instantiation of lead tenant node

$$27 {0}_{i}^{l\_k}$$

on the cloud based cluster, and lead tenant node 270 may support instantiation of other tenant nodes

$$27 {0}_{i}^{w\_k} ,$$

w≠l that are part of the node pool/cluster 207-i as outlined above.

In some embodiments, upon obtaining the cluster image, the tenant node

$$27 {0}_{i}^{l\_k}$$

may reboot to the OS (based on the received image) and following reboot may execute any initial custom layer implementation (e.g. custom implementation 142-i) scripts and perform various configurations (e.g. network, filesystem, etc.). In some embodiments, one or more of the tasks above may be orchestrated by Configuration Engine

$${281}_{i}^{w\_k} .$$

After configuring the system in accordance with system composition specification S 150, as outlined above, tenant nodes

$$27 {0}_{i}^{w\_k}$$

may form part of node pool k/cluster 207-i in distributed system as composed by a user. The process above may be performed for each node pool and cluster. In some embodiments, the configuration of node pools in a cluster may be performed in parallel. In some embodiments, when the distributed system includes a plurality of clusters, clusters may be configured in parallel.

In some embodiments, management agent

$$26 {2}_{i}^{l\_k}$$

on a lead tenant node

$$27 {0}_{i}^{{l}_{-} k}$$

may obtain state information

$$26 {8}_{i}^{{w}_{-} k}$$

and cluster profile information

$$26 {4}_{i}^{{w}_{-} k}$$

for nodes

$$27 {0}_{i}^{{w}_{-} k}$$

in a node pool k in cluster 207-i and may provide that information to DPE 202. The information (e.g. state information

$$26 {8}_{i}^{{w}_{-} k}$$

and cluster profile information

$$26 {4}_{i}^{{w}_{-} k} )$$

may be sent periodically, upon request (e.g. by DPE 202), or upon occurrence of one or more state change events to DPE 202 (e.g. as part of cluster specification updates 278). In some embodiments, when the current state (e.g. based on state information

$$26 {8}_{i}^{{w}_{-} k} )$$

does not correspond to a declared (or desired) state (e.g. as outlined in system composition specification 150) and/or system composition does not correspond to a declared (or desired) composition (e.g. as outlined in system composition specification 150), then DPE 202 and/or management agent

$$26 {2}_{i}^{{l}_{-} k}$$

may take remedial action to bring the system state and/or system composition into compliance with system composition specification 150. For example—if a system application is accidentally or
deliberately deleted, then DPE 207 and/or management agent

$$26 {2}_{i}^{l}$$

may reinstall (or be instructed to reinstall) the deleted system application during a subsequent reconciliation. As another example, changes to the OS layer implementation, such as the deletion of a kernel module, may result in the module being reinstalled. As a further example, system composition specification 150 (or node pool specification portion 180-k of cluster specification 180) may specify a node count for a master pool, and a node count for the worker node pools. When a current number of running nodes deviates from the count specified (e.g. in cluster specification 180) then, DPE 207 and/or management agent

$$26 {2}_{i}^{{l}_{-} k}$$

may add or delete nodes to bring number of nodes into compliance with system composition specification 150.

In some embodiments, composable system may also facilitate seamless changes to the composition of the distributed system. For example, cluster specification updates 278 may provide: (a) user changes to cluster configurations (e.g. via cluster management block), and/or (b) cluster profile changes/updates (e.g. change to security layer 131 in cluster profile 104, addition/deletion of layers) to management agent

$$26 {2}_{i}^{{w}_{-} k}$$

on node

$$27 {0}_{i}^{{w}_{-} k} .$$

Cluster specification updates 278 may reflect a new or changed desired system state, which may be declaratively applied to the cluster (e.g. by management agent

$$26 {2}_{i}^{{w}_{-} k}$$

using configuration engine

$$28 {1}_{i}^{{w}_{-} k} ) .$$

In some embodiments, the updates may be applied in a rolling fashion to bring the system in compliance with the new declared state (e.g. as reflected by cluster specification updates 278). For example, nodes 270 may be updated one at a time, so that other nodes can continue running thus ensuring system availability. Thus, the composable distributed system and applications executing on the composable distributed system may continue running as the system is updated. In some embodiments, cluster specification updates 278 may specify that upon detection of any failures, or errors, a rollback to a prior state (e.g. prior to the attempted update) should be initiated.

Disclosed embodiments thus facilitate the specification and automated deployment of end-to-end composable distributed systems, while continuing to support orchestration, deployment, and scaling of applications, including containerized applications.

FIG. 2B shows another example architecture 275 to facilitate composition of a distributed system comprising one or more clusters 207. The architecture 275 shown in FIG. 2B supports the specification, orchestration, deployment, monitoring, and updating of a composable distributed system and of applications running on the composable distributed system. In some embodiments, composable distributed system may be a distributed computing system, where one or more of the functional units may be cloud-based. In some embodiments, the composable distributed system may be implemented using some combination of: cloud based systems and/or services, and/or physical hardware.

As shown in FIG. 2B, DPE 202 may be provided in the form of a SaaS and may include functionality and/or functional blocks similar to those described above in relation to FIG. 2A. For example, DPE 202 may serve as a control block and provide node/cluster management, user management, role based access control (RBAC), cluster management including cluster profile management, monitoring, reporting, and other capabilities to facilitate composition of distributed system 275.

DPE 202 may be used (e.g. by a user) to store cluster configuration information 288, pack configuration information 284 (e.g. including layer implementation information, adapter information, cluster profile location information, cluster profile parameters 155, and content), ISO images 286 (e.g. cluster images, BM bootstrap images, adapter/container images, management agent images) and container registry 282 (not shown in FIG. 2B) in repository 280 in a manner similar to the description above for FIG. 2A.

In some embodiments, DPE 202 may initiate composition of a cluster 207-i that forms part of the composable distributed system by sending an initiate deployment command 277 to pilot cluster 279. For example, a first “cluster create” command identifying cluster 207-i, a cluster specification 150, and/or a cluster image (e.g. if already present in repository 280) may be sent to pilot cluster 279. In some embodiments, a Kubernetes “kind cluster create” command or variations thereof may be used to initiate deployment. In some embodiments, cluster specification 150 may be sent to the pilot cluster 279. In embodiments, where one or more clusters 207 or node pools form part of a private infrastructure, an authentication mechanism, unique key, and/or identifier may be used by a pilot cluster 279 (and/or a pilot sub-cluster) within the private infrastructure) to obtain the relevant cluster specification 150 from DPE 202. Thus, pilot cluster 279 may include one or more pilot sub-clusters, which may coordinate to deploy the distributed system in accordance with system composition specification S 150.

Pilot cluster 279 may include one or more nodes that may be used to deploy a composable distributed system comprising node pool k cluster 207-i. In some embodiments, pilot cluster 279 (or a pilot sub-cluster) may be co-located with the to-be-deployed composable distributed system comprising node pool k in cluster 207-i. In some embodiments, one or more of pilot cluster 279 and/or repository 280 may be cloud based.

In embodiments where cluster 207-i forms part of a public or private cloud, pilot cluster 279 may use system composition specification 150 (e.g. cluster configuration 288, cluster specification 180/node pool parameters 180-k, cluster profile 104, etc.) to build and store appropriate cluster images 253 in the appropriate cloud specific format (e.g. QCOW, OVA, AMI, etc.). The cloud specific image may then be uploaded to the respective image registry (which may specific to the cloud type/cloud provider) by pilot cluster 279. In some embodiments, lead node(s)

$${270}_{i}^{l\_k}$$

for node pool k in cluster 207-i may then be instantiated (e.g. based on the cloud specific images). In some embodiments, upon start up lead nodes

$${270}_{i}^{l\_k}$$

for node pool k in cluster 207-i may obtain the cloud specific images and cloud specification 150, and initiate instantiation of the worker nodes

$${270}_{i}^{w\_k} ,$$

w≠l. Worker nodes

$${270}_{i}^{w\_k} ,$$

w≠l may obtain cloud specific images and cloud specification 150 from lead node(s)

$${270}_{i}^{l\_k} .$$

In embodiments where a node pool k in cluster 207-i includes a plurality of BM nodes

$${270}_{i}^{w\_k} ,$$

upon receiving “initiate deployment” command 277 pilot cluster 279 may use system composition specification 150 (e.g. cluster specification 180, node pool parameters 180-k, cluster profile 104, etc.) to build and store appropriate ISO images 286 in repository 280. A first BM node may upon boot-up (e.g. when in a pre-bootstrap configuration) may register with pilot cluster 279 (e.g. by exchanging lead node registration (Pilot) 266 messages) and be designated as a lead node

$${270}_{i}^{l\_k}$$

(e.g. based on MAC addresses, IP address, subnet address, etc.). In some embodiments, pilot cluster 279 may initiate the transfer of, and/or the (newly designated) lead BM node

$${270}_{i}^{l\_k}$$

may obtain, cluster images 253, which may be flashed (e.g. by management agent

$${262}_{i}^{l\_k}$$

in pre-bootstrap code running on

$${270}_{i}^{l\_k} )$$

to lead BM node

$${270}_{i}^{l\_k} .$$

In some embodiments, the cluster images 253 may be flashed to a bootable drive on lead BM node

$${270}_{i}^{l\_k} .$$

A reboot of lead BM node

$${270}_{i}^{l\_k}$$

may be initiated and, upon reboot, lead BM node

$${270}_{i}^{l\_k}$$

may obtain cluster specification 150 and/or cluster images 253 from repository 280 and/or pilot cluster 279 (e.g. via cluster provisioning 292). The cluster specification 150 and/or cluster images 253 obtained (following reboot) by lead node

$${270}_{i}^{l\_k}$$

from repository 280 and/or pilot cluster 279 may be used to provision additional nodes

$$27 {0}_{i}^{w \_ k} ,$$

w≠l.

In some embodiments, one or more nodes

$$27 {0}_{i}^{w \_ k} ,$$

w≠l, may upon boot-up (e.g. when in a pre-bootstrap configuration) register with lead node

$$27 {0}_{i}^{l \_ k}$$

(e.g. using internode (P2P) communication 259 and may be designated as a worker node (or as another lead node based on corresponding node pool specification 180-k). In some embodiments, lead node

$$27 {0}_{i}^{l \_ k}$$

may initiate the transfer of, and/or BM node

$$27 {0}_{i}^{w \_ k}$$

may obtain, cluster images 253, which may be flashed (e.g. by management agent

$${262}_{i}^{w \_ k}$$

in pre-bootstrap code running on

$$27 {0}_{i}^{w \_ k} )$$

to the corresponding BM node

$$27 {0}_{i}^{w \_ k} .$$

In some embodiments, the cluster images 253 may be flashed to a bootable drive on BM node

$$27 {0}_{i}^{w \_ k}$$

(e.g. following registration with lead node

$$27 {0}_{i}^{l \_ k} ) .$$

A reboot of BM node

$$27 {0}_{i}^{w \_ k}$$

may be initiated and, upon reboot, BM node

$$27 {0}_{i}^{w \_ k}$$

may join (and form part of) node pool k in cluster 207-i with one or more lead nodes

$$27 {0}_{i}^{l \_ k}$$

in accordance with system composition specification 150. In some embodiments, upon reboot, nodes

$$27 {0}_{i}^{w \_ k}$$

and/or management agent

$$26 {2}_{i}^{w \_ k}$$

may install any additional layer implementations, system addons, and/or system applications (if not already installed) in order to reflect cluster profile 104-i.

According to aspects of the present disclosure, a self-discovering, self-healing overlay Virtual Extensible LAN (VXLAN) network is presented that can operate between cluster nodes. This network efficiently handles underlay IP changes, ensuring constant communication and stability within the cluster.

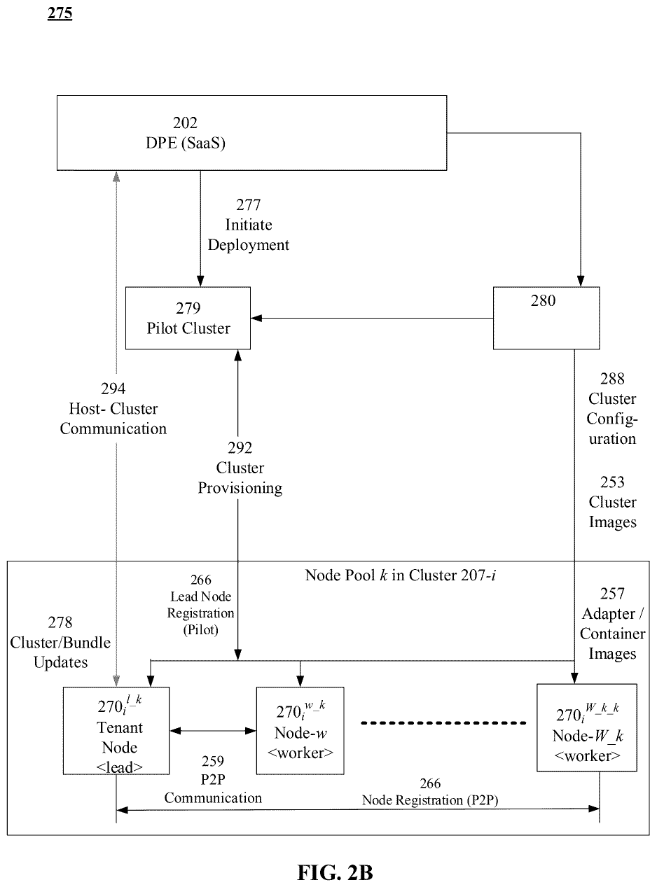

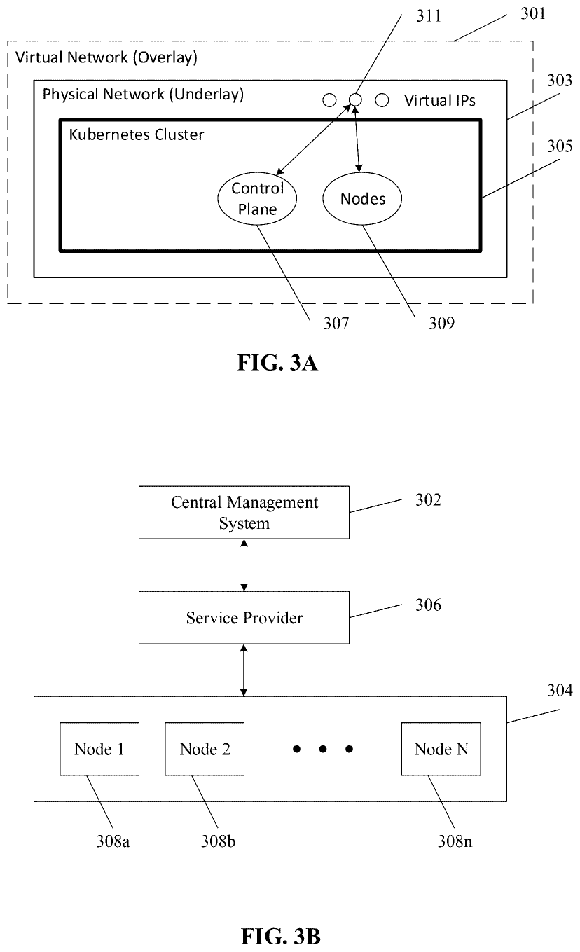

FIG. 3A illustrates an exemplary overlay VXLAN network according to aspects of the present disclosure. In the example shown in FIG. 3A, a virtual network 301 (overlay) includes a physical network 303 (underlay). The physical network 303 includes a Kubernetes cluster 305, which in turn includes control plane 307 and nodes 309. In the virtual network, the virtual IP addresses may be used by the control plane 307 and nodes 309.

According to aspects of the present disclosure, Kubernetes cluster can be configured to use an overlay VXLAN network, where the assigned virtual IPs 311 do not change during the cluster lifespan, the underlying network IP change does not affect the cluster. Kubernetes nodes and CNI (Container Network Interface) layer may run on the overlay network.

FIG. 3B illustrates an example of cluster configuration using an overlay network according to aspects of the present disclosure. In the example of FIG. 3B, a central management system 302 is configured to set up the Kubernetes cluster 304 via the Internet of a service provider 306. In addition, the central management system 302 may be configured to perform other tasks, such as node management, cluster management, policy management, and cluster profile management as described above. A Kubernetes cluster may include a plurality of nodes, namely node 1 (308a), node 2 (308b) . . . node N (308n). Each node may include a management agent and a configuration engine. The applications of the management agent (such as performing discovery service, etc.) and the configuration engine are described in the sections below. The central management system 302 takes the cluster configuration input and saves it as cluster profile. An overlay network can be chosen as a configuration option for the cluster. In some embodiments, an Overlay Network CIDR (Classless Inter-Domain Routing) of a user's choice may be specified. In some other embodiments, a default value may be chosen for a user if desired.

According to aspects of the present disclosure, a user can specify other configurations for the cluster, such as operating system, CNI (Container Network Interface)/CSI (Container Storage Interface) layer and other applications as part of cluster profile for the cluster creation. The central management system 302, where all the nodes are registered, is configured to send the cluster profile specification to all the nodes in the cluster 304.

Cluster creation is handled by the management agent running on each node. This management agent communicates with the central management system and acts on the cluster profile specification. The management agent registers to the central management system on the host system boot up.

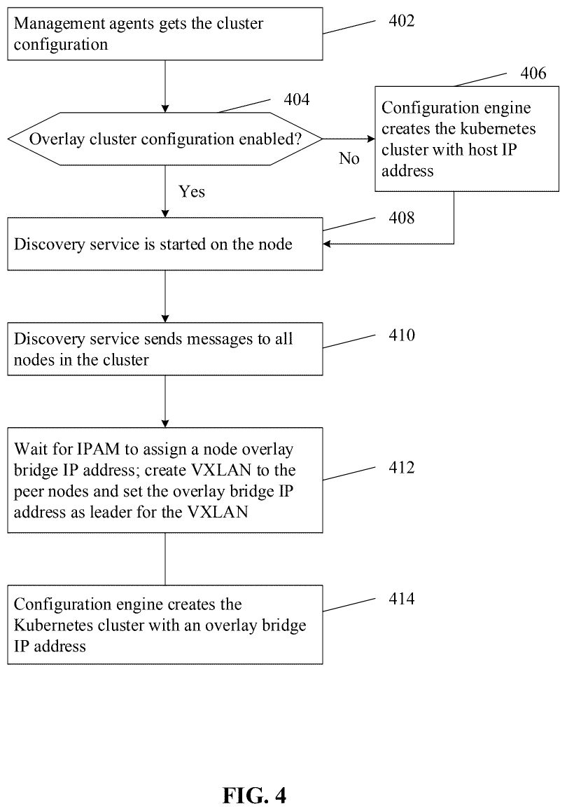

FIG. 4 illustrates an exemplary flowchart of cluster creation on a Kubernetes node according to aspects of the present disclosure. As shown in the exemplary flowchart of FIG. 4, in block 402, the management agent gets cluster configuration specification from the central management system. In some embodiments, the cluster configuration specification may have an Overlay Configuration flag enabled when a user selects Overlay Network for cluster deployment, and an Overlay Network CIDR (Classless Inter-Domain Routing).

In block 404, a determination is made on whether an overlay cluster configuration is enabled. If the overlay cluster configuration is enabled (404_Yes), the flowchart moves to block 408. Else if the overlay cluster configuration is not enabled (404_No), the flowchart moves to block 406. In block 406, the configuration engine creates the Kubernetes cluster with host IP address. In block 408, the management agent on the node starts the discovery service. In block 410, the management agent sends messages to all nodes in the cluster via the discovery service. According to aspects of the present disclosure, a discovery service may be implemented across all nodes in the cluster. The discovery service helps setting up the initial overlay network configuration needed to create the cluster and also handles an underlay network IP Address change.

In block 412, the management agent waits for an IP Address Management (IPAM) process to assign a node overlay bridge IP address. Then, the management agent creates VXLAN to the peer nodes and sets overlay bridge IP address as leader for the VXLAN. In some embodiments, for each peer node, the management agent creates a VXLAN with destination IP as the peer host IP and adds this VXLAN as member to the bridge interface. The management agent also sets any additional configuration flag (for example, API-advertise-address, node-external-IP or node-IP) used by a specific Kubernetes provider.

In block 414, the configuration engine creates the Kubernetes cluster with an overlay bridge IP address. In some embodiments, the configuration engine running on the node takes the cluster configuration and sets up the Kubernetes cluster using the overlay network. In addition, the configuration engine applies the cluster configuration to the Kubernetes cluster and then monitors its operation.

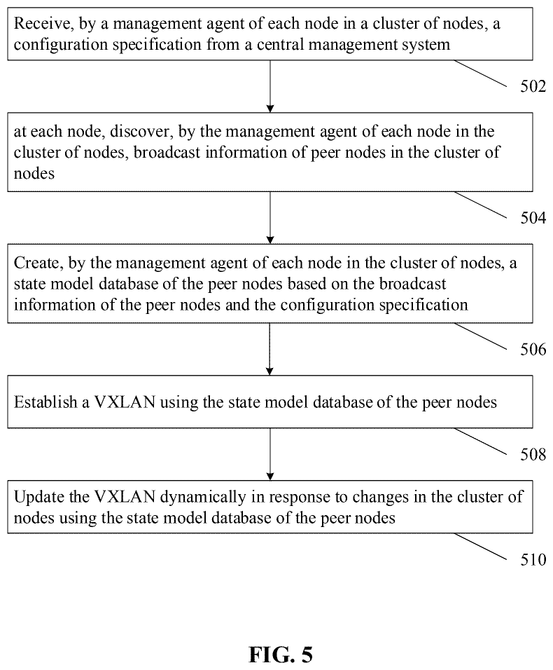

FIG. 5 illustrates an exemplary implementation of configuring a VXLAN in a distributed computing environment according to aspects of the present disclosure. In the exemplary implementation of FIG. 5, in block 502, the method receives, by a management agent of each node in a cluster of nodes, a configuration specification from a central management system. In block 504, at each node, the method discovers, by the management agent of each node in the cluster of nodes, broadcast information of peer nodes in the cluster of nodes. In block 506, the method creates, by the management agent of each node in the cluster of nodes, a state model database of the peer nodes based on the broadcast information of the peer nodes and the configuration specification. In block 508, the method establishes a VXLAN using the state model database of the peer nodes. In block 510, the method updates the VXLAN dynamically in response to changes in the cluster of nodes using the state model database of the peer nodes.

According to aspects of the present disclosure, the cluster is a Kubernetes cluster, and changes in the cluster of nodes include: network disruptions, and changes to peer IP addresses and changes to peer conditions. The management agent of each node performs its functions without Internet connection to the central management system residing in a cloud environment.

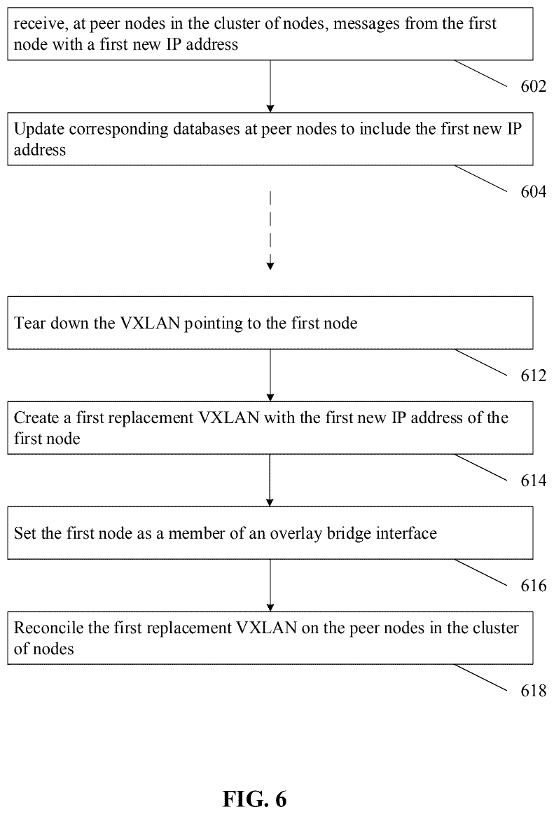

FIG. 6 illustrates an exemplary implementation of updating the VXLAN dynamically in response to a node having an IP address change according to aspects of the present disclosure. As shown in the example of FIG. 6, in response to a first node in the cluster of nodes having underlay network IP address change, in block 602, the method receives, at peer nodes in the cluster of nodes, messages from the first node with a first new IP address. In block 604, the method updates corresponding databases at peer nodes to include the first new IP address.

According to aspects of the present disclosure, the method of updating corresponding databases at peer nodes in block 604 may optionally/additionally include the methods performed in block 612 through block 618. In block 612, the method tears down the VXLAN pointing to the first node. In block 614, the method creates a first replacement VXLAN with the first new IP address of the first node. In block 616, the method sets the first node as a member of an overlay bridge interface. In block 618, the method reconciles the first replacement VXLAN on the peer nodes in the cluster of nodes.

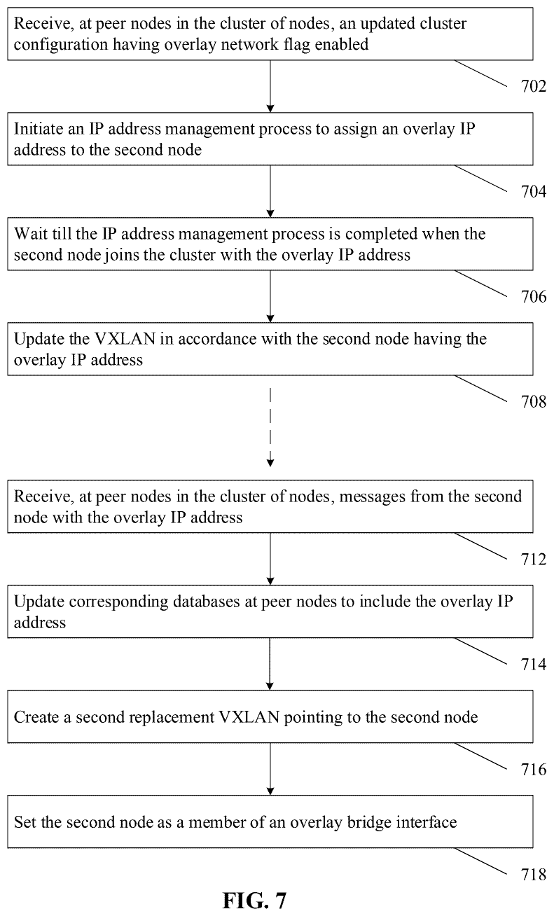

FIG. 7 illustrates an exemplary implementation of updating the VXLAN dynamically in response to a node joining the cluster of nodes according to aspects of the present disclosure. As shown in FIG. 7, in response to a second node joining the cluster of nodes, in block 702, the method receives, at peer nodes in the cluster of nodes, an updated cluster configuration having overlay network flag enabled. In block 704, the method initiates an IP address management process to assign an overlay IP address to the second node. In block 706, the method waits till the IP address management process is completed when the second node joins the cluster with the overlay IP address. In block 708, the method updates the VXLAN in accordance with the second node having the overlay IP address.

According to aspects of the present disclosure, the method of updating the VXLAN in accordance with the second node having the overlay IP address of block 708 may optionally/additionally include the methods performed in blocks 712 through 718. In block 712, the method receives, at peer nodes in the cluster of nodes, messages from the second node with the overlay IP address. In block 714, the method updates corresponding databases at peer nodes to include the overlay IP address. In block 716, the method creates a second replacement VXLAN pointing to the second node. In block 718, the method sets the second node as a member of an overlay bridge interface.

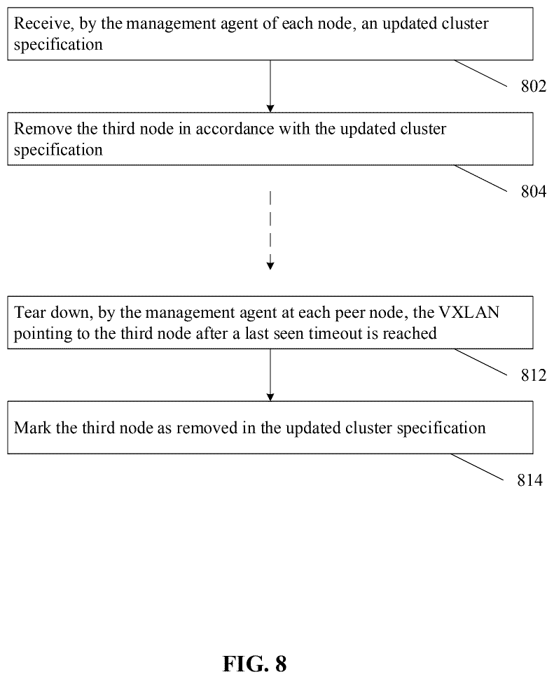

FIG. 8 illustrates an exemplary implementation of updating the VXLAN dynamically in response to removing a node from the cluster of nodes according to aspects of the present disclosure. In the example as shown in FIG. 8, in response to a third node to be removed from the cluster of nodes, in block 802, the method receives, by the management agent of each node, an updated cluster specification. In block 804, the method removes the third node in accordance with the updated cluster specification.

According to aspects of the present disclosure, the methods performed in block 802 and block 804 may optionally/additionally include the methods performed in block 812 and block 814. In block 812, the method tears down, by the management agent at each peer node, the VXLAN pointing to the third node after a last seen timeout is reached. In block 814, the method marks the third node as removed in the updated cluster specification.

According to aspects of the present disclosure system and method for managing IP address changes in Kubernetes clusters is disclosed, particularly in edge environments, through the implementation of a self-healing overlay network. This system addresses the challenges associated with DHCP IP changes by introducing an Overlay VXLAN network and a dedicated discovery service that facilitates seamless communication and IP address management among cluster nodes.

In some embodiments, an overlay VXLAN network is employed that operates between cluster nodes, providing a stable foundation for communication even in dynamic IP environments. A dedicated discovery service is implemented across all nodes within the cluster, enabling real-time detection of IP address changes triggered by DHCP assignments. In the event of an IP address change, the discovery service initiates a notification process to inform peer nodes, triggering dynamic adjustments within the overlay network to accommodate the new IP configurations. Public/private key encryption is employed to authenticate communication between cluster nodes, ensuring the integrity and confidentiality of data exchanged within the cluster. The solution adopts a distributed IPAM approach, allowing nodes to negotiate IP assignments without reliance on a central DHCP server, thereby improving scalability and fault tolerance.

The advantages of the present disclosure include seamless handling of DHCP IP changes in Kubernetes clusters, ensuring continuous stability and availability even in dynamic edge environments. Reduced manual intervention and configuration overhead, leading to improved operational efficiency and reliability. Enhanced security through encryption-based authentication, safeguarding cluster communication against potential threats and vulnerabilities.

In one exemplary embodiment, the methods described above may be adapted to work with edge environments with frequent device movement and network changes, such as situations involving intermittent network connectivity or device shutdowns. For example, a coffee shop or a restaurant running Kubernetes cluster has a network change or some device turned off for a few hours, the local network boots up and gets a new IP address. With conventional approach, the Kubernetes cluster would be downgraded or broken.

With the approach of the present disclosure, the cluster can get a cluster profile from the central management system with overlay configuration enabled. Then, no network expertise would be needed at the edge location to configure the Kubernetes cluster. Upon the nodes get the configuration from the central management system, the overlay network configuration may be performed by an agent running on the node. Even in situations where the network connection to the central management system is broken, impact to the nodes can be minimized, as the configuration can be handled by an agent running locally on the node. An underlay network IP change also gets handled by the agent running on the node itself, without input or intervention needed from the central management system.

The disclosed approach helps the coffee shop or the restaurant run efficiently and gives the local applications more resilience. For example, billing or ordering counter with an application running on Kubernetes cluster of the present disclosure can keep running even if underlying network IP changes or connection to the central management system may be broken.

In another exemplary embodiment, the methods described above may be adapted to assist a shipping container that runs a Kubernetes cluster with applications running to show the progress of the container while it travels across the ocean from one country to another. The shipping container may be connected to a satellite network or a network at the closest country when it starts its journey. In this case, the underlay network IP address can change as the ship travels to different locations and connects to different networks due to different network provider configurations. This change of underlay network IP address can pose problems for conventional approaches that cannot work with changing IP addresses.

With the approach of the present disclosure, the Kubernetes cluster can be configured with overlay network enabled. The nodes can have an Overlay IP address that can be used by the Kubernetes cluster. When the ship travels to a new location and gets a new underlay IP address from a new service provider (for example, a new Satellite connection or provider from a closest country), the agent running on the nodes can detect the IP address change and reconfigure the Overlay Network. No network expertise is needed on the ship to handle the underlay IP change and recover Kubernetes cluster. Moreover, the overlay network configuration can be handled by an agent running locally on the node, it does not need a connection to the central management system running in the cloud. Kubernetes cluster can automatically recover once the agent running on the nodes detects an IP address change and reconfigures the overlay network.

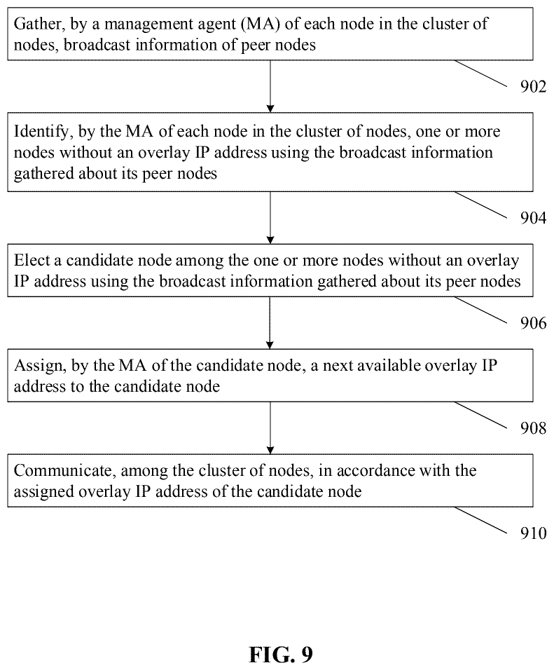

FIG. 9 illustrates an exemplary implementation of IP address management among a cluster of nodes in a distributed computing environment according to aspects of the present disclosure. In the exemplary implementation of FIG. 9, in block 902, the method gathers, by a management agent (MA) of each node in the cluster of nodes, broadcast information of peer nodes. In block 904, the method identifies, by the MA of each node in the cluster of nodes, one or more nodes without an overlay IP address using the broadcast information gathered about its peer nodes. In block 906, the method elects a candidate node among the one or more nodes without an overlay IP address using the broadcast information gathered about its peer nodes. In block 908, the method assigns, by the MA of the candidate node, a next available overlay IP address to the candidate node. In block 910, the method communicates, among the cluster of nodes, in accordance with the assigned overlay IP address of the candidate node.

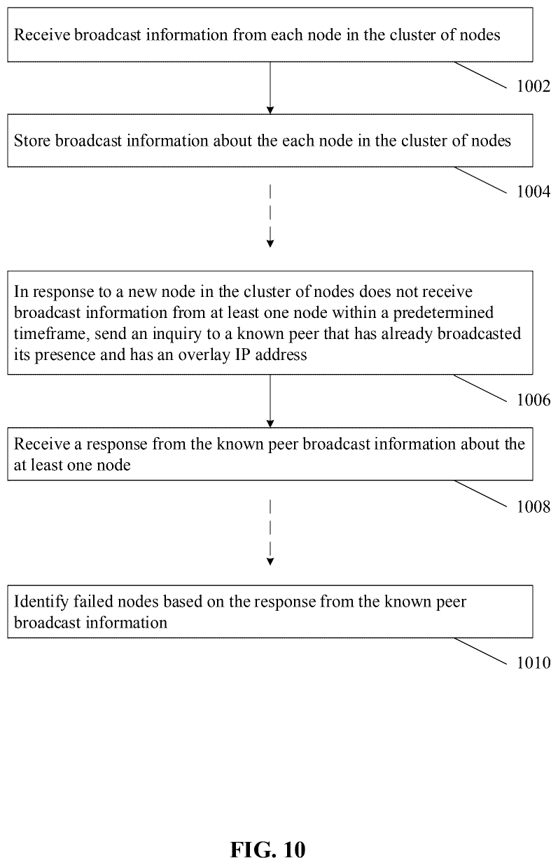

FIG. 10 illustrates an exemplary implementation of gathering broadcast information of peer nodes according to aspects of the present disclosure. As shown in FIG. 10, in block 1002, the method receives broadcast information from each node in the cluster of nodes. In block 1004, the method stores broadcast information about each node in the cluster of nodes.

According to aspects of the present disclosure, the methods performed in block 1002 and block 1004 may optionally/additionally include the methods performed in block 1006 and block 1008. In block 1006, in response to a new node in the cluster of nodes not receiving broadcast information from at least one node within a predetermined time frame, the method sends an inquiry to a known peer that has already broadcasted its presence and has an overlay IP address. In block 1008, the method receives a response from the known peer broadcast information about the at least one node.

According to aspects of the present disclosure, the methods performed in block 1006 and block 1008 may optionally/additionally include the method performed in block 1010. In block 1010, the method identifies failed nodes based on the response from the known peer broadcast information.

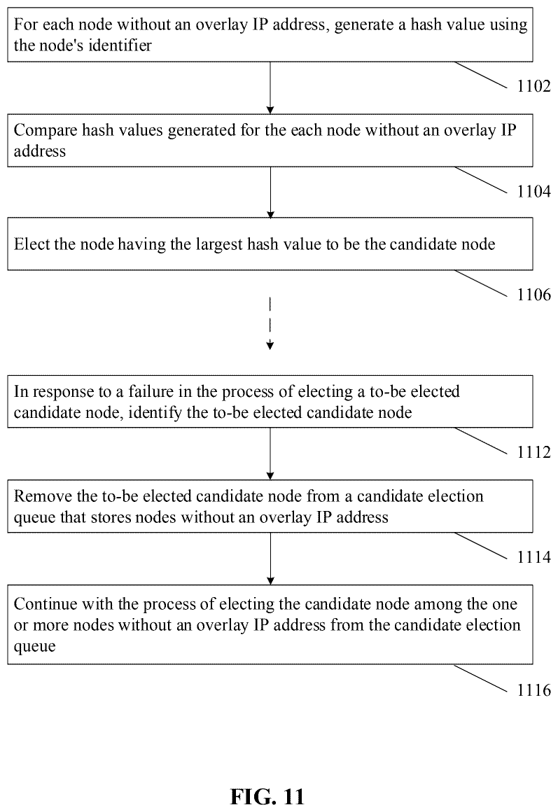

FIG. 11 illustrates an exemplary implementation of electing a candidate node for IP address assignment according to aspects of the present disclosure. In the example of FIG. 11, in block 1102, for each node without an overlay IP address, the method generates a hash value using the node's identifier (node ID). In block 1104, the method compares hash values generated for each node without an overlay IP address. In block 1106, the method elects the node having the largest hash value to be the candidate node.

According to aspects of the present disclosure, the methods performed in blocks 1102 through block 1106 may optionally/additionally include the methods performed in block 1112 through block 1116. In block 1112, in response to a failure in the process of electing a to-be elected candidate node, the method identifies the to-be elected candidate node. In block 1114, the method removes the to-be elected candidate node from a candidate election queue that stores nodes without an overlay IP address. In block 1116, the method continues with the process of electing the candidate node among the one or more nodes without an overlay IP address from the candidate election queue.

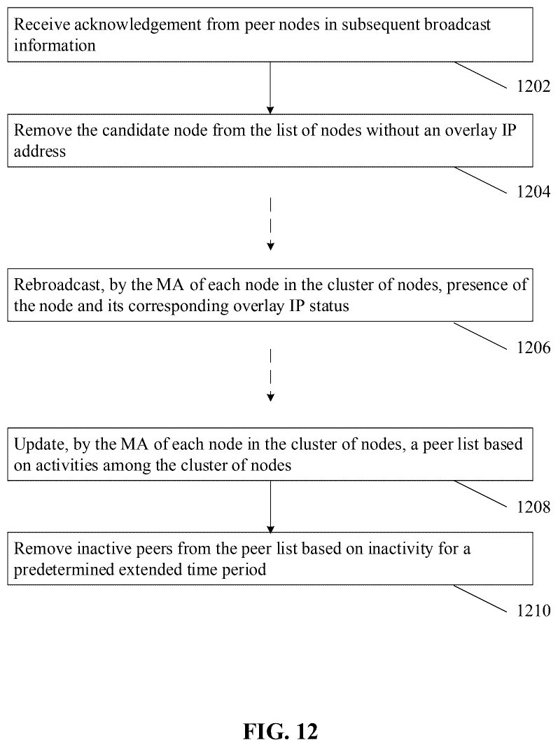

FIG. 12 illustrates an exemplary implementation of assigning a next available overlay IP to a candidate node according to aspects of the present disclosure. As shown in the example of FIG. 12, in block 1202, the method receives acknowledgement from peer nodes in subsequent broadcast information. In block 1204, the method removes the candidate node from the list of nodes without an overlay IP address.

According to aspects of the present disclosure, the methods performed in block 1202 and block 1204 may optionally/additionally include the method performed in block 1206. In block 1206, the method rebroadcasts, by the MA of each node in the cluster of nodes, presence of the node and its corresponding overlay IP status.

According to aspects of the present disclosure, the methods performed in block 1206 may optionally/additionally include the method performed in block 1208 and block 1210. In block 1208, the method updates, by the MA of each node in the cluster of nodes, a peer list based on activities among the cluster of nodes. In block 1210, the method removes inactive peers from the peer list based on inactivity for a predetermined extended time period.

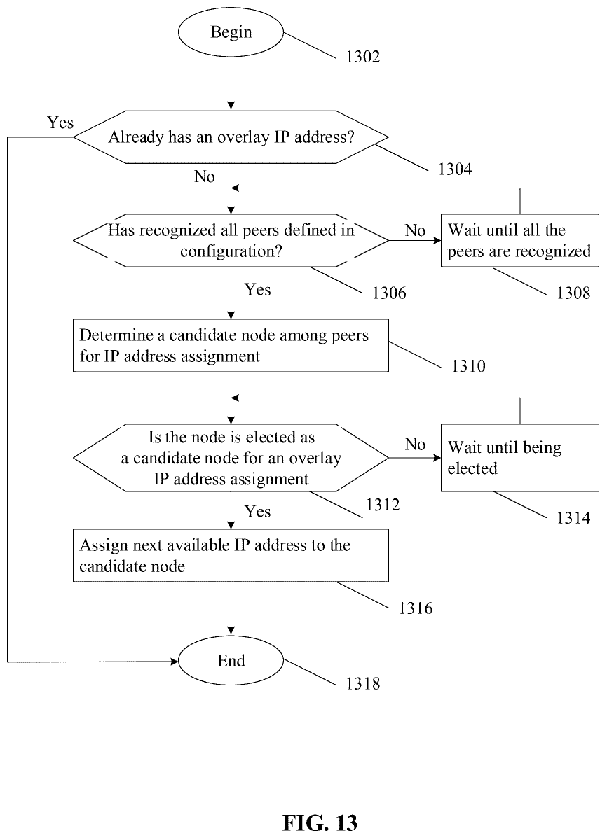

Conventional centralized solutions of IP address management typically require a central dynamic host configuration protocol (DHCP) server to assign IP addresses to nodes on a network. The disclosed IPAM approach is differentiated from conventional centralized solutions as each node in the network negotiates with one another to prevent IP address conflicts. The disclosed IPAM processes can run independently on each node in the network, thus enhancing robustness of the system and eliminating single points of failure. Each node in the network operates its own independent IPAM process, and an exemplary process is described below in association with FIG. 13.

FIG. 13 illustrates an exemplary flowchart of each node in a cluster of nodes independently managing its IP address allocation while coordinating with its peers according to aspects of the present disclosure. As shown in the exemplary flowchart of FIG. 13, the IPAM process starts when a node lacks an overlay IP address in block 1302, and moves to block 1304.

In block 1304, a first inquiry is made as to whether the node already has an overlay IP address? If the node already has an overlay IP address (1304_Yes), the process moves to block 1318. Else if the node does not have an overlay IP address (1304_No), the process moves to block 1306.

In block 1306, a second inquiry is made as to whether the node has recognized all peers defined in its configuration. If the node has recognized all peers defined in its configuration (1306_Yes), the process moves to block 1310. Else if the node has not recognized all peers defined in its configuration (1306_No), the process moves block 1308.

In block 1308, the process waits until all the peers are recognized. For example, the node waits to receive broadcast messages from all its peers at least once. Then it returns to block 1306.

In block 1310, the process determines a candidate node among its peers that without an overlay IP address for IP address assignment, and moves to block 1312.

In block 1312, a third inquiry is made as to whether the node is elected as a candidate node for an overlay IP address assignment. If the node is elected as a candidate node for an overlay IP address assignment (1312_Yes), the process moves to block 1316. Else if the node is not elected as a candidate node for an overlay IP address assignment (1312_No), the process moves to block 1314.

In block 1314, the process waits until the node is elected as a candidate node for an overlay IP address assignment, and returns to block 1312.

In block 1316, the process assigns the next available overlay IP address to the elected candidate node, and moves to block 1318. This assignment can be acknowledged by its peers in their subsequent broadcast messages. Peers then remove the node from their list of nodes without an overlay IP. The process ends in block 1318.

Note that this decentralized approach ensures that each node independently managing its IP allocation while coordinating with its peers to prevent conflicts and maintain unique IP assignments within the network.

In some embodiments, the failure modes of the IPAM process can be categorized into two situations: 1) a node fails with an overlay IP address; and 2) a node fails before getting an overlay IP address. In the situation where a node fails with an overlay IP address, for example, consider a cluster with nodes A, B, and C. If node C fails and a new node D attempts to join the cluster, the IPAM process for node D can be blocked since it cannot receive broadcast messages from the failed node C. One exemplary solution to this situation of a node fails with an overlay IP address is to introduce a random walking mechanism. In one approach, if a new node, such as node D, does not receive all peer broadcast messages within a certain timeframe, it can send a direct message to one of its peers that has already broadcasted its presence and has an overlay IP address. This approach assumes that a node with an overlay IP address may know the status of all other nodes with overlay IPs. Thus, this peer node can provide node D with information about the failure of node C, allowing node D to proceed with the IPAM process.

In the situation where a node fails before getting an overlay IP address, for example, if a node fails during the candidate election process, particularly if it is in the process of being elected as the candidate for IP address assignment, the IPAM process can be blocked, especially if multiple nodes are involved in the election. One exemplary solution to this situation of a node fails before getting an overlay IP address is to use an enhanced candidate election algorithm. In one exemplary approach, a different candidate election algorithm may be implemented. This approach ensures that if a node fails during the election process, it can be identified and excluded from the candidate queue after a certain period, allowing the election to continue smoothly.

In view of the situations where a node fails with an overlay IP address or a node fails before getting an overlay IP address, the following modified IPAM process may be implemented:
The IPAM process starts when a node lacks an overlay IP address.
The node waits to receive broadcast messages from all its peers or until a predefined timeout period elapses.
If the timeout expires, the node sends direct messages to peers with overlay IP addresses to gather information about the cluster and identify any failed nodes.
Once a sufficient number of peers are recognized, the node determines if it is the elected candidate for IP address assignment among those without an overlay IP address.
Utilize a fault tolerant candidate election technique to ensure robustness. If the elected candidate node fails, it can be identified and removed from the election process, allowing the election to continue.
If a node is the elected candidate for IP address assignment, it assigns itself the next available overlay IP address.
This assignment is acknowledged by its peers in their subsequent broadcast messages.
Peers then remove the node from their list of nodes without an overlay IP.
Nodes periodically rebroadcast their presence and overlay IP status.
Nodes update their peer list based on recent activity and remove inactive peers after an extended period.

There are numerous benefits of the present disclosure. First, it presents improvements in automated application of virtual private networks (VPNs) and overlay network management. In particular, they provide a stable network environment for Kubernetes clusters in dynamic and distributed edge environments. Unlike traditional VPN solutions that rely on manual configuration and static network topologies, the present disclosure provides approaches that integrate self-discovery, self-healing, dynamic configuration, and IPAM functionalities. By combining these capabilities, the present disclosure offers a comprehensive and automated framework for establishing and maintaining stable and reliable VPN connections for Kubernetes clusters.

According to aspects of the present disclosure, Overlay Network Configuration and Overlay IP Address Management runs on the local node itself. Once the initial Kubernetes Cluster configuration is downloaded to the node, there is no dependency on connection to the Central Management System. The Overlay Network configuration and Overlay IP address assignment to participating nodes is handled by the agent running on the nodes that talk to each other. Even in the failure case, where the underlying network IP address changes, the recovery is handled by a local agent on the nodes. There is no intervention needed from the Central Management System.

In addition, the present disclosure provides abilities to autonomously and securely discover VPN peers in dynamic network environments, adapts to changes in network topology or peer configurations, and dynamically configures VPN tunnels using VXLAN technology. This dynamic and adaptive nature ensures continuous connectivity and resilience against network disruptions or failures, thereby enhancing the reliability and performance of Kubernetes clusters in highly dynamic and distributed environments. Furthermore, the proposed disclosure introduces an integrated IPAM solution that automates IP address management within the dynamic overlay network.

As a result, the combination of self-discovery, self-healing, dynamic configuration, and IPAM functionalities enable improved applications of VPN and overlay network management in the service of Kubernetes clusters.

Some portions of the detailed description that follows are presented in terms of flowcharts, logic blocks, and other symbolic representations of operations on information that can be performed on a computer system. A procedure, computer-executed step, logic block, process, etc., is here conceived to be a self-consistent sequence of one or more steps or instructions leading to a desired result. The steps are those utilizing physical manipulations of physical quantities. These quantities can take the form of electrical, magnetic, or radio signals capable of being stored, transferred, combined, compared, and otherwise manipulated in a computer system. These signals may be referred to at times as bits, values, elements, symbols, characters, terms, numbers, or the like. Each step may be performed by hardware, software, firmware, or combinations thereof.

It will be appreciated that the above descriptions for clarity have described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processors or controllers. Hence, references to specific functional units are to be seen as references to suitable means for providing the described functionality rather than indicative of a strict logical or physical structure or organization.

The embodiments can be implemented in any suitable form, including hardware, software, firmware, or any combination of these. The embodiments may optionally be implemented partly as computer software running on one or more data processors and/or digital signal processors. The elements and components of an embodiment may be physically, functionally, and logically implemented in any suitable way. Indeed, the functionality may be implemented in a single unit, in a plurality of units, or as part of other functional units. As such, the embodiments may be implemented in a single unit or may be physically and functionally distributed between different units and processors.

One skilled in the relevant art will recognize that many possible modifications and combinations of the disclosed embodiments may be used, while still employing the same basic underlying mechanisms and methodologies. The foregoing description, for purposes of explanation, has been written with references to specific embodiments. However, the illustrative discussions above are not intended to be exhaustive or to limit the invention to the precise forms disclosed. Many modifications and variations are possible in view of the above teachings. The embodiments were chosen and described to explain the principles of the invention and their practical applications, and to enable others skilled in the art to best utilize the invention and various embodiments with various modifications as suited to the particular use contemplated.

What is claimed is:

1. A method of IP address management among a cluster of nodes in a distributed computing environment, comprising:
gathering, by a management agent (MA) of each node in the cluster of nodes, broadcast information of peer nodes;
identifying, by the MA of each node in the cluster of nodes, one or more nodes without an overlay IP address using the broadcast information gathered about its peer nodes;
electing a candidate node among the one or more nodes without an overlay IP address using the broadcast information gathered about its peer nodes;
assigning, by the MA of the candidate node, a next available overlay IP address to the candidate node; and
communicating, among the cluster of nodes, in accordance with the assigned overlay IP address of the candidate node.

2. The method of claim 1, wherein gathering broadcast information of peer nodes comprises:
receiving broadcast information from each node in the cluster of nodes; and
storing broadcast information about the each node in the cluster of nodes.

3. The method of claim 2, wherein gathering broadcast information of peer nodes further comprises:
in response to a new node in the cluster of nodes does not receive broadcast information from at least one node within a predetermined timeframe,
sending an inquiry to a known peer that has already broadcasted its presence and has an overlay IP address; and
receiving a response from the known peer broadcast information about the at least one node.

4. The method of claim 3, further comprises:
identifying failed nodes based on the response from the known peer broadcast information.

5. The method of claim 1, wherein electing the candidate node comprises:
for each node without an overlay IP address, generating a hash value using the node's identifier (node ID);
comparing hash values generated for the each node without an overlay IP address; and
electing the node having the largest hash value to be the candidate node.

6. The method of claim 5, wherein electing the candidate node further comprises:
in response to a failure in the process of electing a to-be elected candidate node,
identifying the to-be elected candidate node;
removing the to-be elected candidate node from a candidate election queue that stores nodes without an overlay IP address;
continuing with the process of electing the candidate node among the one or more nodes without an overlay IP address from the candidate election queue.

7. The method of claim 1, wherein assigning a next available overlay IP to the candidate node further comprises:
receiving acknowledgement from peer nodes in subsequent broadcast information; and
removing the candidate node from the list of nodes without an overlay IP address.

8. The method of claim 7, further comprises:
rebroadcasting, by the MA of each node in the cluster of nodes, presence of the node and its corresponding overlay IP status.

9. The method of claim 8, further comprises:
updating, by the MA of each node in the cluster of nodes, a peer list based on activities among the cluster of nodes; and
removing inactive peers from the peer list based on inactivity for a predetermined extended time period.

10. An apparatus for managing IP addresses among a cluster of nodes in a distributed computing environment, comprising:
a management agent residing at each node in a cluster of nodes, implemented with one or more processors, coupled to a memory and a network interface, wherein the management agent is configured to:
gather broadcast information of peer nodes;
identify one or more nodes without an overlay IP address using the broadcast information gathered about its peer nodes;
elect a candidate node among the one or more nodes without an overlay IP address using the broadcast information gathered about its peer nodes;
assign a next available overlay IP address to the candidate node; and
communicate, among the cluster of nodes, in accordance with the assigned overlay IP address of the candidate node.

11. The apparatus of claim 10, wherein the management agent is further configured to:
receive broadcast information from each node in the cluster of nodes; and
store broadcast information about the each node in the cluster of nodes.

12. The apparatus of claim 11, wherein the management agent is further configured to:
in response to a new node in the cluster of nodes does not receive broadcast information from at least one node within a predetermined timeframe,
send an inquiry to a known peer that has already broadcasted its presence and has an overlay IP address; and
receive a response from the known peer broadcast information about the at least one node.

13. The apparatus of claim 12, wherein the management agent is further configured to:
identify failed nodes based on the response from the known peer broadcast information.

14. The apparatus of claim 10, wherein the management agent is further configured to:
for each node without an overlay IP address, generate a hash value using the node's identifier (node ID);
compare hash values generated for the each node without an overlay IP address; and
elect the node having the largest hash value to be the candidate node.

15. The apparatus of claim 14, wherein the management agent is further configured to:
in response to a failure in the process of electing a to-be elected candidate node,
identify the to-be elected candidate node;
remove the to-be elected candidate node from a candidate election queue that stores nodes without an overlay IP address;
continue with the process of electing the candidate node among the one or more nodes without an overlay IP address from the candidate election queue.

16. The apparatus of claim 10, wherein the management agent is further configured to:
receive acknowledgement from peer nodes in subsequent broadcast information; and
remove the candidate node from the list of nodes without an overlay IP address.

17. The apparatus of claim 16, wherein the management agent is further configured to:
rebroadcast presence of the node and its corresponding overlay IP status.

18. The apparatus of claim 17, wherein the management agent is further configured to:
update a peer list based on activities among the cluster of nodes; and
remove inactive peers from the peer list based on inactivity for a predetermined extended time period.

19. A non-transitory computer-readable medium comprising instructions to configure a processor to:
gather broadcast information of peer nodes;
identify one or more nodes without an overlay IP address using the broadcast information gathered about its peer nodes;
elect a candidate node among the one or more nodes without an overlay IP address using the broadcast information gathered about its peer nodes;
assign a next available overlay IP address to the candidate node; and
communicate in accordance with the assigned overlay IP address of the candidate node.
